(19) United States
(12) Patent Application Publication
(10) Pub. No.: US 2025/0184068 A1
(43) Pub. Date: Jun. 5, 2025

(54) METHOD FOR TRANSMITTING INFORMATION, AND DEVICE AND STORAGE MEDIUM

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 18/844,110

(22) PCT Filed: Mar. 11, 2022
(86) PCT No.: PCT/CN2022/080465

§ 371 Date: Sep. 5, 2024

(51) Int. Cl. H04L 5/00; H04W 16/28

(52) U.S. Cl. CPC H04L 5/005; H04W 16/28

(57) ABSTRACT

The present application relates to the field of mobile communications, and provides a method for transmitting information, and a device and a storage medium. The method includes: a first device receives beam information sent by a second device, the beam information indicating beam information corresponding to at least one reference signal resource, and the at least one reference signal resource including a resource for beam measurement.

### CROSS-REFERENCE TO RELATED APPLICATIONS

The present application is a U.S. National Stage Application of International Application No. PCT/CN2022/080465, filed on Mar. 11, 2022, the entire contents of which are incorporated herein by reference for all purposes.

### TECHNICAL FILED

The present application relates to the field of mobile communications and, in particular, to a method for transmitting information, device and storage medium.

### BACKGROUND

In a mobile communication system, a network device configures, for a terminal, periodic reference signal resources for beam measurement. The terminal performs measurement based on the configured reference signal resources accordingly and provides feedback to the network device on quality of measured reference signals. However, the reference signal resources configured in the above-described manner are limited, resulting in poor accuracy of the quality of the measured reference signals.

### SUMMARY

Embodiments of the present application provide a method and apparatus for transmitting information, device and storage medium, by which information of at least one reference signal resource is extended, and a first device can perform a quality prediction for a beam measurement based on beam information of the at least one reference signal resource, to improve the accuracy of the beam measurement. The technical solution is as follows.

According to an aspect of the present application, a method for transmitting information is provided. The method is performed by a first device, the method including:
receiving beam information from a second device, where the beam information indicates beam information corresponding to at least one reference signal resource, the at least one reference signal resource including a resource for beam measurement.

According to an aspect of the present application, a method for transmitting information is provided. The method is performed by a second device, the method including:
sending beam information to a first device, wherein the beam information indicates beam information corresponding to at least one reference signal resource, the at least one reference signal resource including a resource for beam measurement.

According to an aspect of the present application, a device is provided, the device including: a processor; a transceiver connected to the processor; and a memory for storing instructions executable by the processor; where the processor is configured to load and execute the instructions to implement the method for transmitting information as in the above aspect.

According to an aspect of the present application, a non-transitory computer-readable storage medium is provided, the readable storage medium storing an executable program code which, when loaded and executed by a processor, causes the processor to implement the method for transmitting information as in the above aspect.

### BRIEF DESCRIPTION OF THE DRAWINGS

In order to more clearly illustrate the technical solution in the embodiments of the present application, the accompanying drawings to be used in the description of the embodiments will be briefly introduced below. It is obvious that the accompanying drawings in the following description are only some of the embodiments of the present application, and that for the person of ordinary skill in the field, other accompanying drawings can be obtained based on the accompanying drawings without creative labor.

FIG. 1 illustrates a block diagram of a communication system provided by an embodiment of the present application.

FIG. 2 illustrates a flowchart of a method for transmitting information provided by an embodiment of the present application.

FIG. 3 illustrates a schematic diagram of a beam direction provided by an embodiment of the present application;

FIG. 4 illustrates a schematic diagram of a beam direction provided by an embodiment of the present application.

FIG. 5 illustrates a flowchart of a method for transmitting information provided by an embodiment of the present application.

FIG. 6 illustrates a flowchart of a method for transmitting information provided by an embodiment of the present application.

FIG. 7 illustrates a block diagram of an information transmission apparatus provided by an embodiment of the present application.

FIG. 8 illustrates a block diagram of an information transmission apparatus provided by an embodiment of the present application.

FIG. 9 illustrates a schematic structural diagram of a communication device provided by an embodiment of the present application.

### DETAILED DESCRIPTION

In order to make the purpose, technical solutions and advantages of the present application clearer, the following will describe the embodiments of the present application in further detail in conjunction with the accompanying drawings.

Embodiments will be described in detail herein, examples of which are represented in the accompanying drawings. When the following description relates to the accompanying drawings, unless otherwise indicated, the same numerals in different accompanying drawings indicate the same or similar elements. The embodiments described in the following embodiments do not represent all embodiments consistent with the present application. Rather, they are only examples of devices and methods consistent with some aspects of this application as detailed in the appended claims.

The terms used in this application are for the sole purpose of describing particular embodiments and is not intended to limit this application. The singular forms of “a,” “an,” and “this” used in this application and the appended claims are also intended to encompass the plural form, unless the context clearly indicates otherwise. It should also be understood that the term “and/or” as used herein refers to and encompasses any or all possible combinations of one or more of the associated listed items.

It should be understood that while the terms “first,” “second,” “third,” etc. may be employed in this application to describe various types of information, such information should not be limited by these terms. These terms are only used for the purpose of distinctions between multiple pieces of information that is of the same type. For example, without departing from the scope of the present application, first information may also be referred to as second information, and similarly, second information may be referred to as first information. Depending on the context, for example, the word “if” as used herein may be interpreted as “at the time of . . . ” or “when . . . ” or “in response to determining . . . ”.

It should be noted that the information (including, but not limited to, user device information, user personal information, etc.), data (including, but not limited to, data used for analysis, data stored, data displayed, etc.), and signals involved in this application are authorized by the user or fully authorized by the parties, and that the collection, use, and processing of the relevant data need to comply with relevant laws, regulations, and standards of the relevant countries and regions.

Application scenarios of this application are described below.

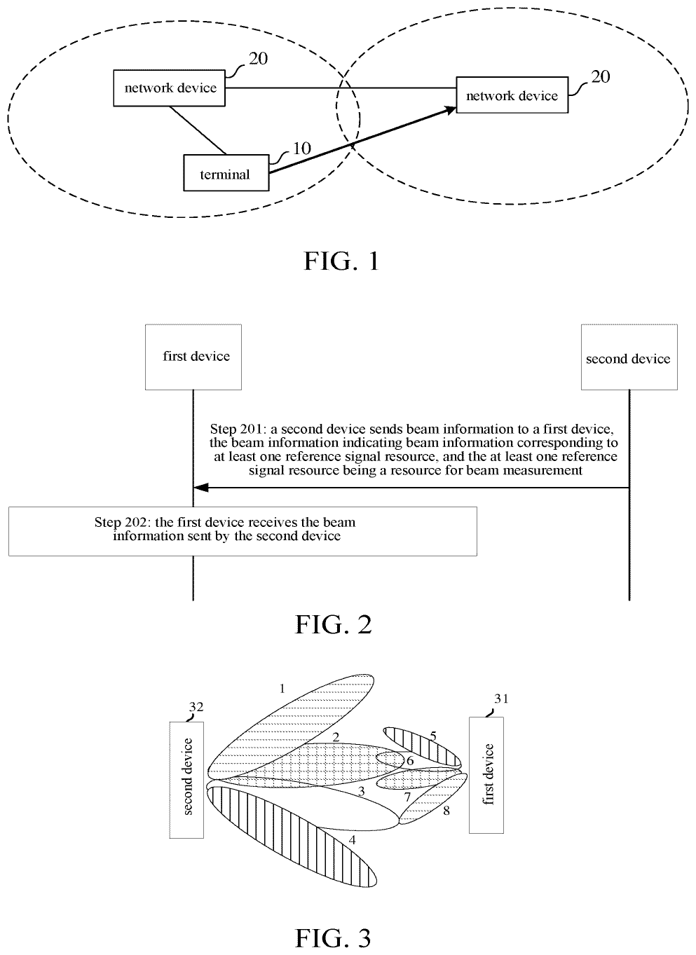

FIG. 1 illustrates a block diagram of a communication system provided by an embodiment of the present application. The communication system may include a terminal 10 and a network device 20.

There are typically a plurality of terminals 10, and one or more terminals 10 may be distributed within each cell managed by the network device 20. The terminals 10 may include a variety of hand-held devices, in-vehicle devices, wearable devices, computing devices, or other processing devices connected to a wireless modem with wireless communication capabilities, as well as various forms of User Equipment (UE), Mobile Station (MS), and the like. For convenience of description, in the embodiments of the present application, the above mentioned devices are collectively referred to as terminals.

The network device 20 is a device deployed in an access network for providing wireless communication functions for the terminal 10. For convenience of description, in the embodiments of the present application, the devices for providing wireless communication functions for the terminal 10 are collectively referred to as network devices. A connection may be established between the network device 20 and the terminal 10 through an air interface, whereby communication, including signaling and data interaction, is carried out through the connection. There may be a plurality of network devices 20, and communication between two neighboring network devices 20 may also be carried out by wired or wireless means. The terminal 10 may switch between different network devices 20, i.e. establish a connection with different network devices 20.

The network devices 20 may include various forms of macro base stations, micro base stations, relay stations, access points, and the like. In systems using different wireless access technologies, the name of the device having the function of a network device may be different. For example, in a 5G NR system, it is called a gNodeB or a gNB. As communication technologies evolve, the name “network device” may change.

It should be noted that the first device in the embodiments of the present application may be a terminal in the above embodiment, and the second device may be a network device in the above embodiment. Alternatively, the first device may be a network device in the above embodiment, and the second device may be a terminal in the above embodiment. One gNB may include one or more Transmission Reception Points (TRPs), or one gNB may include one or more antenna panels.

FIG. 2 illustrates a flowchart of a method for transmitting information provided by an embodiment of the present application. Exemplarily, the method can be performed by a first device and a second device as shown in FIG. 1, the method including at least some of the following contents.

Step 201, sending, by the second device, beam information to the first device, where the beam information indicates beam information corresponding to at least one reference signal resource, the at least one reference signal resource including a resource for beam measurement.

Step 202, receiving, by the first device, the beam information sent by the second device.

In the embodiment of the present application, the second device sends the beam information indicating the at least one reference signal resource to the first device, and then the first device may receive the beam information sent by the second device. In this case, the at least one reference signal resource includes a resource for beam measurement. That is, after the second device sends the beam information to the first device, the first device may determine information related to the reference signal resource of the second device based on the beam information, so as to facilitate the first device to measure at least one reference signal based on the at least one reference signal resource. After determining the signal quality of the at least one reference signal, based on the signal quality of the at least one reference signal obtained from the measurement, and the beam information corresponding to the reference signal resource, the first device may predict the signal quality of the unmeasured reference signal other than the at least one reference signal.

In this embodiment, the second device may send different reference signals to the first device based on the at least one reference signal resource, and the first device measures the reference signals based on the at least one reference signal resource to determine qualities of the respective reference signals sent by the second device.

It should be noted that “beam measurement” in the embodiment of the present application means measuring the at least one reference signal to obtain Layer 1 Reference Signal Received Power (L1-RSRP) and/or Layer 1 Signal to Interference plus Noise Ratio (L1-SINR) of the at least one reference signal.

Reference signals include a Synchronization Signal Block (SSB), a Channel State Information Reference Signal (CSI-RS), and a Sounding Reference Signal (SRS). Beam indication is an indication of a Transmission Configuration Indication (TCI) state. The TCI state includes at least one of Quasi Co-Location (QCL) types including QCL Type A, QCL Type B, QCL Type C, and QCL Type D. The QCL type D is reception parameter information, which may be referred to as a beam. Type A, Type B, and Type C each includes at least one of the following related parameters: Doppler shift, Doppler spread, average delay, or delay spread.

In some embodiments, the first device is a terminal and the second device is a network device.

In the embodiment of the present application, when the first device is a terminal and the second device is a network device, the network device sends beam information to the terminal. The terminal receives the beam information to determine the at least one reference signal resource used for the beam measurement and the beam information corresponding to the at least one reference signal resource. The terminal can then measure the signal quality of the at least one reference signal based on the at least one reference signal resource, and predict the signal quality of the unmeasured other reference signal(s), with reference to the beam information sent by the network device and the signal quality of the at least one reference signal that has been measured.

Optionally, the reference signal resource includes a Synchronization Signal Block (SSB) resource or a Channel State Information Reference Signal (CSI-RS) resource.

In the embodiment of the present application, the network device configures a reference signal resource for the terminal, sends an SSB or a CSI-RS to the terminal via the reference signal resource, so as to facilitate the terminal to receive the SSB or the CSI-RS sent by the network device, and conduct a measurement for the SSB or the CSI-RS to obtain the signal quality of at least one reference signal. In addition, the terminal can also predict the signal quality of the unmeasured other reference signal(s) based on the beam information and the signal quality of the at least one reference signal that has been measured.

In other embodiments, the first device is a network device and the second device is a terminal.

In the embodiment of the present application, when the first device is a network device and the second device is a terminal, the terminal sends beam information to the network device. The network device receives the beam information and can determine at least one reference signal resource used for the beam measurement and beam information corresponding to the at least one reference signal resource. The network device can then measure the signal quality of the at least one reference signal based on the at least one reference signal resource, and predict the signal quality of the unmeasured other reference signal(s), with reference to the beam information sent by the terminal and the signal quality of the reference signal that has been measured.

Optionally, the reference signal resource is an SRS resource. In the embodiment of the present application, when the reference signal resource configured by the network device for the terminal is an SRS resource, the terminal may send an SRS to the network device based on the configured reference signal resource, so as to facilitate the network device to measure the SRS, obtain the signal quality of the reference signal, and also predict the signal quality of the unmeasured other reference signal(s), based on the beam information and the signal quality of the reference signal that has been measured.

It should be noted that the steps performed by the terminal in the embodiments of the present application may be implemented separately to form a new embodiment, and the steps performed by the network device may be implemented separately to form a new embodiment.

In the solution provided in the present application, the second device sends to the first device the beam information indicating at least one reference signal resource that is used for the beam measurement, so as to facilitate the first device to determine a relationship between the at least one reference signal resource and the corresponding beam, extending the information of the at least one reference signal resource that is sent by the second device. In addition, the first device can also, based on the beam information of the at least one reference signal resource, carry out a quality prediction for the beam measurement, improving the accuracy of the beam measurement.

Hereinafter, a description is provided with respect to how the first device predicts the signal quality of the unmeasured other reference signal(s). The beam information corresponding to the at least one reference signal resource is used for the first device to predict the signal quality of the unmeasured other reference signal(s), based on this beam information and the signal quality of the reference signal(s) of partially referenced signal resources. In other words, the first device measures at least one reference signal based on at least one reference signal resource to obtain the signal quality of the at least one reference signal, and the first device also predicts the signal quality of the unmeasured other reference signal(s), based on the received beam information as well as the signal quality of the at least one reference signal that has been measured.

The predicted signal quality of the unmeasured other reference signal may include the signal quality corresponding to all of the combinations of the receiving beams of the first device and the reference signals; or the signal quality corresponding to a portion of the combinations of the receiving beams of the first device and the reference signals. For example, only the strongest signal quality of each reference signal that can be obtained when each reference signal is received using all the receiving beams is predicted.

In some embodiments, the second device 32 is a network device and the second device 32 sends different reference signals. The first device 31 is a terminal, and the first device 31 uses at least one receiving beam of itself to receive the reference signals sent by the second device respectively. Alternatively, the second device 32 is a terminal and the second device 32 sends different reference signals. The first device 31 is a network device, and the first device 31 uses at least one receiving beam of itself to receive the reference signals sent by the second device respectively.

For example, as shown in FIG. 3, the second device 32 is provided with a transmitting beam 1, a transmitting beam 2, a transmitting beam 3, and a transmitting beam 4, through which a reference signal 1, a reference signal 2, a reference signal 3, and a reference signal 4 are sent, respectively. The first device 31 is provided with a receiving beam 5, a receiving beam 6, a receiving beam 7, and a receiving beam 8, through which the reference signals sent by the second device 32 are received, respectively. That is, the first device 31 can receive the reference signal 1, the reference signal 2, the reference signal 3, and the reference signal 4 sent by the second device 32 through the receiving beam 5. The first device 31 can also receive the reference signal 1, the reference signal 2, the reference signal 3, and the reference signal 4 sent by the second device 32 through the receiving beam 6, and so on. Each receiving beam of the first device 31 will be used to receive the reference signal 1, the reference signal 2, the reference signal 3 and the reference signal 4 sent by the second device 32. In addition, the signal quality of each reference signal received by each receiving beam can be measured. In the above description, the first device 31 measures all of the combinations of the reference signals and the receiving beams. In various embodiments, the first device 31 may measure a portion of the combinations of the reference signals and the receiving beams. After the first device 31 measures the signal quality of the reference signals, it can also predict the signal quality of the unmeasured other reference signal(s), based on the beam information and the combinations of the reference signals and the receiving beams.

In some embodiments, the first device determines the signal quality of the unmeasured reference signal(s) other than the at least one reference signal, based on the signal quality of the at least one reference signal and beam information corresponding to the at least one reference signal resource.

Optionally, the first device sorts signal qualities of the at least one reference signal according to transmitting beam identifiers corresponding to the at least one reference signal resource and/or at least one receiving beam identifier, and determines the signal quality of the unmeasured other reference signal(s) based on the sorted reference signal qualities and a signal quality prediction model.

In the embodiment of the present application, each receiving beam of the first device has a corresponding identifier. When determining the signal quality of the unmeasured other reference signal(s) based on the beam information of the at least one reference signal resource and the signal qualities of the reference signals received through the receiving beams, the first device sorts the signal qualities of the reference signals in accordance with the identifiers of the receiving beams, or, the first device sorts the signal qualities of the reference signals in accordance with the identifiers of the transmitting beams corresponding to the reference signals, or, the first device sorts the signal qualities of the reference signals in accordance with the identifiers of the receiving beams and the identifiers of the transmitting beams corresponding to the reference signals. The sorted signal qualities of the reference signals are subsequently input into the signal quality prediction model to determine the signal quality of the unmeasured other reference signal(s).

For example, the signal qualities of the at least one reference signal are sorted in accordance with the identifiers of the receiving beams of the first device and/or the identifiers of the transmitting beams. After the sorting, a matrix sequence is obtained and is then input into the signal quality prediction model. In this way, the signal quality of the reference signal(s) other than the at least one reference signal can be obtained.

It should be noted that in the embodiment of the present application, when sorting the signal qualities of the at least one reference signal, if there is a reference signal whose signal quality has not been measured, the signal quality of this reference signal is set to “0”.

For example, the signal qualities of the reference signals are sorted in accordance with both the identifiers of the receiving beams and the identifiers of the transmitting beams. When the first device is provided with 2 receiving beams and the second device sends 4 reference signals through 4 transmitting beams, the matrix sequence to be input into the signal quality prediction model includes 8 parameters. The 8 parameters form the matrix sequence having 1 column and 8 rows, including the following signal qualities: the signal quality corresponding to the receiving beam 1 of the first device and the transmitting beam 1 of the second device; the signal quality corresponding to the receiving beam 1 of the first device and the transmitting beam 2 of the second device; the signal quality corresponding to the receiving beam 1 of the first device and the transmitting beam 3 of the second device; the signal quality corresponding to the receiving beam 1 of the first device and the transmitting beam 4 of the second device; the signal quality corresponding to the receiving beam 2 of the first device and the transmitting beam 1 of the second device; the signal quality corresponding to the receiving beam 2 of the first device and the transmitting beam 2 of the second device; the signal quality corresponding to the receiving beam 2 of the first device and the transmitting beam 3 of the second device; and the signal quality corresponding to the receiving beam 2 of the first device and the transmitting beam 4 of the second device.

For the matrix input into the signal quality prediction model, the 8 signal qualities in the matrix are set in such a way that: for a combination of a receiving beam and a reference signal whose signal quality has been measured by the first device, the corresponding parameter in the matrix is set to the signal quality of this reference signal; and for a combination of a receiving beam and a reference signal whose signal quality has not been measured by the first device, the corresponding parameter in the matrix is set to “0”. Subsequently, the signal quality prediction model processes the input matrix to obtain an output matrix by which the signal qualities of all reference signals can be determined.

For example, the matrix obtained by the first device after sorting the signal qualities of the reference signals based on the identifiers of the receiving beams and the identifiers of the transmitting beams is:

$$[ \begin{matrix}RSRP \#1 \\ RSRP \#2 \\ RSRP \#3 \\ RSRP \#4 \\ RSRP \#5 \\ RSRP \#6 \\ RSRP \#7 \\ RSRP \#8\end{matrix} ] = [ \begin{matrix}0 \\ RSRP \#2 \\ 0 \\ 0 \\ RSRP \#5 \\ 0 \\ RSRP \#7 \\ RSRP \#8\end{matrix} ] .$$

The obtained matrix is input into the signal quality prediction model, based on which a processed matrix can be output:

$$[ \begin{matrix}RSRP \#1 \\ RSRP \#2 \\ RSRP \#3 \\ RSRP \#4 \\ RSRP \#5 \\ RSRP \#6 \\ RSRP \#7 \\ RSRP \#8\end{matrix} ] .$$

This matrix can represent the signal qualities of the respective reference signals.

Optionally, the first device groups the signal qualities of the at least one reference signal in accordance with the transmitting beam identifiers corresponding to the at least one reference signal resource and/or at least one receiving beam identifier, and based on the grouped signal qualities of the reference signals and the signal quality prediction model, the first device determines the signal quality of the unmeasured other reference signal(s).

In the embodiment of the present application, each receiving beam has a corresponding identifier. When determining the signal quality of the unmeasured other reference signal(s), the signal qualities of the reference signals received through receiving beams are first grouped in accordance with the identifiers of these receiving beams, in order to obtain the signal qualities of the reference signals belonging to the different groups. Based on the grouped signal qualities of the reference signals and the signal quality prediction model, the signal quality of the unmeasured other reference signal(s) is then determined, which has the same beam information as the receiving beam corresponding to at least one reference signal. Alternatively, when determining the signal quality of the unmeasured other reference signal(s), the signal qualities of the reference signals sent through transmitting beams are first grouped in accordance with the identifiers of these transmitting beams, in order to obtain the signal qualities of the reference signals belonging to the different groups. Based on the grouped signal qualities of the reference signals and the signal quality prediction model, the signal quality of the unmeasured other reference signal(s) is then determined, which has the same beam information as the transmitting beam corresponding to the at least one reference signal.

According to the solution provided in the embodiment of the present application, signal qualities corresponding to the same receiving beam are grouped together. Specifically, the following signal qualities are divided into a group: the signal quality corresponding to the receiving beam 1 of the first device and the transmitting beam 1 of the second device; the signal quality corresponding to the receiving beam 1 of the first device and the transmitting beam 2 of the second device; the signal quality corresponding to the receiving beam 1 of the first device and the transmitting beam 3 of the second device; and the signal quality corresponding to the receiving beam 1 of the first device and the transmitting beam 4 of the second device. The following signal qualities are divided into another group: the signal quality corresponding to the receiving beam 2 of the first device and the transmitting beam 1 of the second device; the signal quality corresponding to the receiving beam 2 of the first device and the transmitting beam 2 of the second device; the signal quality corresponding to the receiving beam 2 of the first device and the transmitting beam 3 of the second device; and the signal quality corresponding to the receiving beam 2 of the first device and the transmitting beam 4 of the second device.

The solution of the embodiments of the present application for predicting the signal quality of the reference signal is similar to the above embodiments and will not be repeated herein.

It should be noted that the signal quality prediction model in the embodiments of the present application is stored in advance in the first device. Alternatively, the signal quality prediction model in the embodiments of the present application is stored in a server and sent by the server to the first device. The first device then predicts the signal quality of the reference signal based on the signal quality prediction model.

On the basis of the embodiment shown in FIG. 2, the beam information includes information of an associated reference signal resource subset of the at least one reference signal resource.

In the embodiment of the present application, the beam information indicates the at least one reference signal resource for the beam measurement and may also be configured with an associated reference signal resource subset associated with the at least one reference signal resource. Accordingly, the beam information may include information of the associated reference signal resource subset of the at least one reference signal resource, to indicate associated reference signal resources.

For each reference signal resource in the at least one reference signal resource, the reference signal resource is configured with an associated reference signal resource subset. That is, if the at least one reference signal resource includes a plurality of reference signal resources, and each reference signal resource is associated with an associated reference signal resource subset, the plurality of reference signal resources are associated with a plurality of associated reference signal resource subsets.

In some embodiments, information of the associated reference signal resource subset includes an identifier of the associated reference signal resource subset and an identifier of a reference signal resource in the associated reference signal resource subset.

In the embodiments of the present application, since the beam information includes an associated reference signal resource subset associated with the at least one reference signal resource (i.e., the beam information is required to include information indicating the associated reference signal resource subset), the associated reference signal resource subset is indicated by an identifier of the associated reference signal resource subset, and a reference signal resource in each associated reference signal resource subset is indicated by an identifier of the reference signal resource.

For example, identifiers of the associated reference signal resource subsets included in the beam information are: an associated reference signal resource subset A, an associated reference signal resource subset B, and an associated reference signal resource subset C. In addition, the associated reference signal resource subset A includes an associated reference signal resource 1, an associated reference signal resource 2, and an associated reference signal resource 3. The associated reference signal resource subset B includes an associated reference signal resource 4 and an associated reference signal resource 5. The associated reference signal resource subset C includes an associated reference signal resource 6.

Optionally, the associated reference signal resource subset includes a reference signal resource that is in a same set of reference signal resources as the at least one reference signal resource.

In the embodiment of the present application, the at least one reference signal resource is associated with one or more associated reference signal resource subsets, and each associated reference signal resource subset includes at least one reference signal resource. The associated reference signal resource subset includes a reference signal resource that is in a same set of reference signal resources as the at least one reference signal resource.

Optionally, the associated reference signal resource subset includes a reference signal resource that is in a different set of reference signal resources from the at least one reference signal resource.

In the embodiment of the present application, the at least one reference signal resource is associated with one or more associated reference signal resource subsets, and each associated reference signal resource subset includes at least one reference signal resource. The associated reference signal resource subset includes a reference signal resource that is in a different set of reference signal resources from the at least one reference signal resource.

That is, for the configured associated reference signal resource subsets associated with the at least one reference signal resource, the reference signal resources included in these associated reference signal resource subsets may belong to the same set of reference signal resources as the at least one reference signal resource, or may not belong to the same set of reference signal resources as the at least one reference signal resource, which is not limited in the embodiments of the present application. In other words, for a reference signal resource and an associated reference signal resource subset having an association relationship, the reference signal resource and the associated reference signal resource subset may belong to the same set of reference signal resources, or the reference signal resource and the associated reference signal resource subset may belong to different sets of reference signal resources.

Optionally, the associated reference signal resource subset includes a reference signal resource having a beam direction within a range of a beam direction of the at least one reference signal resource.

In the embodiment of the present application, each reference signal resource has a corresponding beam direction. For the above-mentioned at least one reference signal resource, the range of the beam direction of the at least one reference signal resource covers a beam direction of a reference signal resource included in the associated reference signal resource subset. That is, the beam of the at least one reference signal resource is wide, and the beam corresponding to the reference signal resource included in the associated reference signal resource subset is narrower. Thus, the associated reference signal resource subset includes a reference signal resource having a beam direction within a range of a beam direction of the at least one reference signal resource.

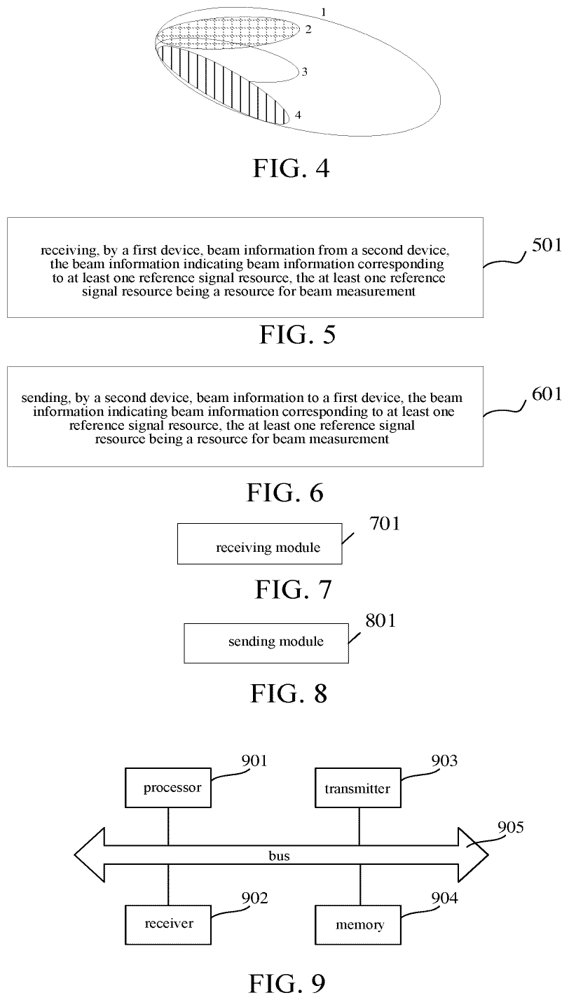

For example, referring to FIG. 4, a range of a beam direction of a beam 1 corresponding to a reference signal resource 1 is large. Beam directions of a beam 2 of a reference signal resource 2, a beam 3 of a reference signal resource 3, and a beam 4 of a reference signal resource 4 included in the associated reference signal resource subset associated with the reference signal resource 1 are all within the range of the beam direction of the beam 1.

It should to be noted that if the associated reference signal resource subset in the embodiment of the present application includes a reference signal resource whose beam direction is within a range of a beam direction of the at least one reference signal resource, when predicting the signal quality of the unmeasured other reference signal(s) based on the signal quality of the at least one reference signal as well as the at least one reference signal resource, the signal quality of the reference signal of at least one reference signal resource in the associated reference signal resource subset can be predicted according to the reference signal quality of the reference signal resource with a larger beam direction range.

For example, referring to FIG. 4, if the associated reference signal resource subset associated with the reference signal resource 1 includes three reference signal resources, namely, the reference signal resource 2, the reference signal resource 3, and the reference signal resource 4, and the beam directions of the reference signal resource 2, the reference signal resource 3, and the reference signal resource 4 fall within the range of the beam direction of the reference signal resource 1, the signal qualities of the reference signals of the reference signal resource 2, the reference signal resource 3, and the reference signal resource 4 included in the associated reference signal resource subset can be output, based on the signal quality prediction model and the input signal quality of the reference signal of the reference signal resource 1.

Optionally, the associated reference signal resource subset includes a reference signal resource having a beam direction adjacent to a beam direction of the at least one reference signal resource.

The beam directions are adjacent, which means that the beam directions of two reference signal resources are in an adjacency relationship. For example, referring to FIG. 4, the beam directions of the reference signal resources include a beam direction 2, a beam direction 3, and a beam direction 4, where the beam direction 2 and the beam direction 3 are in an adjacency relationship, and the beam direction 3 and the beam direction 4 are in an adjacency relationship. That is, when reference signal resources included in the associated reference signal resource subset have beam directions including the beam direction 2, the beam direction 3, and the beam direction 4, and a beam direction of the above-described at least one reference signal resource is the beam direction 3, it is indicated that the associated reference signal resource subset includes a reference signal resource having a beam direction adjacent to a beam direction of the at least one reference signal resource.

In the embodiment of the present application, for the configuration of associated reference signal resources associated with the at least one reference signal resource, the beam directions of these associated reference signal resources may be within the range of the beam direction of the at least one reference signal resource, or may not be within the range of the beam direction of the at least one reference signal resource, which is not limited in the embodiment of the present application.

Additionally, for the associated reference signal resource subset, a first dimensional direction angle and/or a second dimensional direction angle is/are also different from that of the at least one reference signal resource.

Optionally, the associated reference signal resource subset includes a reference signal resource having a first dimensional direction angle within a range of first dimensional direction angles of the at least one reference signal resource, and/or, the associated reference signal resource subset includes a reference signal resource having a second dimensional direction angle within a range of second dimensional direction angles of the at least one reference signal resource.

It should be noted that the first dimensional direction angle of the reference signal resource in the embodiments of the present application refers to the first dimensional direction angle of the beam corresponding to the reference signal resource. That is, “the first dimensional direction angle of the reference signal resource” in the embodiments of the present application can also be referred to as “the first dimensional direction angle of the beam corresponding to the reference signal resource”. The second dimensional direction angle of the reference signal resource in the embodiments of the present application refers to the second dimensional direction angle of the beam corresponding to the reference signal resource. That is, “the second dimensional direction angle of the reference signal resource” in the embodiments of the present application can also be referred to as “the second dimensional direction angle of the beam corresponding to the reference signal resource”.

In the embodiment of this application, there are three main situations included.

Situation 1: the associated reference signal resource subset includes a reference signal resource having a first dimensional direction angle within a range of first dimensional direction angles of the at least one reference signal resource.

For example, if a range of the first dimensional direction angle(s) of the at least one reference signal resource is from 0 degrees to 120 degrees, all of the first dimensional direction angle(s) of the reference signal resource(s) included in the associated reference signal resource subset lie in the range of 0-120 degrees.

For example, if the associated reference signal resource subset includes a reference signal resource 1, a reference signal resource 2, and a reference signal resource 3, and the reference signal resource 1 has a first dimensional direction angle of 30 degrees, the reference signal resource 2 has a first dimensional direction angle of 60 degrees, and the reference signal resource 3 has a first dimensional direction angle of 90 degrees, it is indicated that the first dimensional direction angles of the three reference signal resources included in the associated reference signal resource subset all fall within the range of the first dimensional direction angle(s) of at least one reference signal resource.

Situation 2: the associated reference signal resource subset includes a reference signal resource having a second dimensional direction angle within a range of second dimensional direction angles of the at least one reference signal resource.

For example, if a range of the second dimensional direction angle(s) of the at least one reference signal resource is from 0 degrees to 120 degrees, all of the second dimensional direction angle(s) of the reference signal resource(s) included in the associated reference signal resource subset lie in the range of 0-120 degrees.

For example, if the associated reference signal resource subset includes a reference signal resource 1, a reference signal resource 2, and a reference signal resource 3, and the reference signal resource 1 has a second dimensional direction angle of 30 degrees, the reference signal resource 2 has a second dimensional direction angle of 60 degrees, and the reference signal resource 3 has a second dimensional direction angle of 90 degrees, it is indicated that the second dimensional direction angles of the three reference signal resources included in the associated reference signal resource subset all fall within the range of the second dimensional direction angle(s) of at least one reference signal resource.

Situation 3: the associated reference signal resource subset includes a reference signal resource having a first dimensional direction angle within a range of first dimensional direction angles of the at least one reference signal resource; and the associated reference signal resource subset includes a reference signal resource having a second dimensional direction angle within a range of second dimensional direction angles of the at least one reference signal resource.

The situation 3 in the embodiment of the present application is similar to the above two situations in the embodiments and will not be repeated herein.

Optionally, the associated reference signal resource subset includes a reference signal resource having a first dimensional direction angle adjacent to a first dimensional direction angle of the at least one reference signal resource, and/or, the associated reference signal resource subset includes a reference signal resource having a second dimensional direction angle adjacent to a second dimensional direction angle of the at least one reference signal resource.

In the embodiment of this application, there are three main situations included.

Situation 1: the associated reference signal resource subset includes a reference signal resource having a first dimensional direction angle adjacent to a first dimensional direction angle of the at least one reference signal resource.

First dimensional direction angles are adjacent, which means that the first dimensional direction angles of two reference signal resources are adjacent. For example, if the first dimensional direction angles include 0 degrees, 30 degrees, 60 degrees, and 90 degrees, 0 degrees and 30 degrees are adjacent, 30 degrees and 60 degrees are adjacent, and 60 degrees and 90 degrees are adjacent.

For example, the reference signal resources included in the associated reference signal resource subset all have a first dimensional direction angle of 30 degrees, and the at least one reference signal resource has a first dimensional direction angle of 60 degrees, which indicates that the associated reference signal resource subset includes a reference signal resource having a first dimensional direction angle adjacent to a first dimensional direction angle of the at least one reference signal resource.

Situation 2: the associated reference signal resource subset includes a reference signal resource having a second dimensional direction angle adjacent to a second dimensional direction angle of the at least one reference signal resource.

Second dimensional direction angles are adjacent, which means that the second dimensional direction angles of two reference signal resources are adjacent. For example, if the second dimensional direction angles include 0 degrees, 40 degrees, 80 degrees, and 120 degrees, 0 degrees and 40 degrees are adjacent, 40 degrees and 80 degrees are adjacent, and 80 degrees and 120 degrees are adjacent.

For example, the reference signal resources included in the associated reference signal resource subset all have a second dimensional direction angle of 80 degrees, and the at least one reference signal resource has a second dimensional direction angle of 40 degrees, which indicates that the associated reference signal resource subset includes a reference signal resource having a second dimensional direction angle adjacent to a second dimensional direction angle of the at least one reference signal resource.

Situation 3: the associated reference signal resource subset includes a reference signal resource having a first dimensional direction angle adjacent to a first dimensional direction angle of the at least one reference signal resource, and the associated reference signal resource subset includes a reference signal resource having a second dimensional direction angle adjacent to a second dimensional direction angle of the at least one reference signal resource.

In the solution provided in the embodiment of the present application, information of an associated reference signal resource associated with the at least one reference signal resource is added to the beam information to increase the amount of information in the beam information and thereby increase the accuracy of performing the beam measurement.

On the basis of the embodiment shown in FIG. 2, the beam information further includes a reference signal resource subset corresponding to the at least one reference signal resource.

In some embodiments, the beam information includes a reference signal resource subset to which the at least one reference signal resource belongs.

In the embodiments of the present application, each reference signal resource in the at least one reference signal resource has a reference signal resource subset to which it belongs. By means of the at least one reference signal resource, the beam information also includes the reference signal resource subset to which the at least one reference signal resource belongs, so that the reference signal resource subset can also be indicated through the beam information.

For example, the beam information includes an identifier of a reference signal resource subset to which each of the at least one reference signal resource belongs.

For example, the at least one reference signal resource includes: a reference signal resource 1, a reference signal resource 2, and a reference signal resource 3, the reference signal resource 1 and the reference signal resource 2 belonging to a reference signal resource subset 1, and the reference signal resource 3 belonging to a reference signal resource subset 2.

Optionally, beams of all reference signal resources in the reference signal resource subset are adjacent to each other in direction.

In the embodiment of the present application, beams of all reference signal resources in the reference signal resource subset are adjacent to each other in direction, which means that the beam direction of each reference signal resource is narrower and does not cover the beam direction of other reference signal resources.

The beams of all reference signal resources in the reference signal resource subset are adjacent to each other in direction, similar to the beams of all reference signal resources in the associated reference signal resource subset in the above embodiments, which will not be repeated herein.

Optionally, reference signal resources in the reference signal resource subset have a same first dimensional direction angle, and/or the reference signal resources in the reference signal resource subset have different second dimensional direction angles.

For example, the reference signal resource subset includes a reference signal resource 1, a reference signal resource 2, a reference signal resource 3, and a reference signal resource 4, which all correspond to a first dimensional direction angle of 30 degrees, while the reference signal resource 1 corresponds to a second dimensional direction angle of angle 1, the reference signal resource 2 corresponds to a second dimensional direction angle of angle 2, the reference signal resource 3 corresponds to a second dimensional direction angle of angle 3, and the reference signal resource 4 corresponds to a second dimensional direction angle of angle 4.

In some embodiments, when at least two reference signal resource subsets exist, the at least two reference signal resource subsets correspond to different first dimensional direction angles.

For example, a reference signal resource subset 1 corresponds to a first dimensional direction angle of 30 degrees, a reference signal resource subset 2 corresponds to a first dimensional direction angle of 60 degrees, a reference signal resource subset 3 corresponds to a first dimensional direction angle of 90 degrees, and a reference signal resource subset 4 corresponds to a first dimensional direction angle of 120 degrees.

In the embodiment of the present application, each reference signal resource has a corresponding beam direction. For the above-described at least one reference signal resource, the beam direction of the at least one reference signal resource is adjacent to the beam direction of the reference signal resource included in the associated reference signal resource subset. That is, the beam direction of the at least one reference signal resource does not cover the beam direction of the reference signal resource included in the associated reference signal resource subset, and the beam direction of the at least one reference signal resource and the beam direction of the associated reference signal resource subset are both narrower, thus forming a beam adjacency relationship.

For example, the at least one reference signal resource is associated with four associated reference signal resource subsets, each associated reference signal resource subset includes four reference signal resources, and the four reference signal resources correspond to different second dimensional direction angles.

The reference signal resource subset 1 includes a reference signal resource 1, a reference signal resource 2, a reference signal resource 3, and a reference signal resource 4, which all correspond to a first dimensional direction angle of 30 degrees, and the reference signal resource 1 corresponds to a second dimensional direction angle of angle 1, the reference signal resource 2 corresponds to a second dimensional direction angle of angle 2, the reference signal resource 3 corresponds to a second dimensional direction angle of angle 3, and the reference signal resource 4 corresponds to a second dimensional direction angle of angle 4.

The reference signal resource subset 2 includes a reference signal resource 5, a reference signal resource 6, a reference signal resource 7, and a reference signal resource 8, which all correspond to a first dimensional direction angle of 60 degrees, while the reference signal resource 5 corresponds to a second dimensional direction angle of angle 1, the reference signal resource 6 corresponds to a second dimensional direction angle of angle 2, the reference signal resource 7 corresponds to a second dimensional direction angle of angle 3, and the reference signal resource 8 corresponds to a second dimensional direction angle of angle 4.

The reference signal resource subset 3 includes a reference signal resource 9, a reference signal resource 10, a reference signal resource 11, and a reference signal resource 12, which all correspond to a first dimensional direction angle of 90 degrees, while the reference signal resource 9 corresponds to a second dimensional direction angle of angle 1, the reference signal resource 10 corresponds to a second dimensional direction angle of angle 2, the reference signal resource 11 corresponds to a second dimensional direction angle of angle 3, and the reference signal resource 12 corresponds to a second dimensional direction angle of angle 4.

The reference signal resource subset 4 includes a reference signal resource 13, a reference signal resource 14, a reference signal resource 15, and a reference signal resource 16, which all correspond to a first dimensional direction angle of 120 degrees, while the reference signal resource 13 corresponds to a second dimensional direction angle of angle 1, the reference signal resource 14 corresponds to a second dimensional direction angle of angle 2, the reference signal resource 15 corresponds to a second dimensional direction angle of angle 3, and the reference signal resource 16 corresponds to a second dimensional direction angle of angle 4.

It should be noted that the first dimensional direction angle of the reference signal resource subset in the above embodiments is proportional to the identifier of the reference signal resource subset. That is, the larger the identifier of the reference signal resource subset is, the larger the first dimensional direction angle of the reference signal resource subset is. In addition, the second dimensional direction angle of the reference signal resource included in the reference signal resource subset is proportional to the identifier of the reference signal resource. That is, the larger the identifier of the reference signal resource in the reference signal resource subset, the larger the second dimensional direction angle of the reference signal resource.

In the embodiment of the present application, if the beam information indicates a range of the first dimensional direction angles of the at least one reference signal resource and also includes the number of reference signal resource subsets, the first dimensional direction angle of the reference signal resource subset may be determined.

Optionally, an angular interval of the first dimensional direction angles between two adjacent reference signal resource subsets is determined based on the range of the first dimensional direction angles and the number of reference signal resource subsets, and then a value of the first dimensional direction angle of each reference signal resource subset is determined based on the angular interval.

For example, if a range of the first dimensional direction angles is from −90 degrees to 90 degrees, and the number of reference signal resource subsets is five, an angular interval of the first dimensional direction angles of two adjacent reference signal resource subsets is determined to be 45 degrees. Specifically, the first dimensional direction angle of the first reference signal resource subset is 90 degrees, the first dimensional direction angle of the second reference signal resource subset is 45 degrees, the first dimensional direction angle of the third reference signal resource subset is 0 degrees, the first dimensional direction angle of the fourth reference signal resource subset is −45 degrees, and the first dimensional direction angle of the fifth reference signal resource subset is −90 degrees.

If the beam information indicates a range of the second dimensional direction angles of the at least one reference signal resource and also includes the number of reference signal resources included in the reference signal resource subset, a second dimensional direction angle of each reference signal resource subset of the reference signal resource subsets can be determined.

Optionally, an angular interval of the second dimensional direction angles between two adjacent reference signal resource subsets is determined based on the range of the second dimensional direction angles and a number of reference signal resource subsets, and then a value of the second dimensional direction angle of each reference signal resource subset is determined based on the angular interval.

For example, if a range of the second dimensional direction angles is from −90 degrees to 90 degrees, and the number of reference signal resource subsets is five, an angular interval of the second dimensional direction angles of two adjacent reference signal resource subsets is determined to be 45 degrees. Specifically, the second dimensional direction angle of the first reference signal resource subset is 90 degrees, the second dimensional direction angle of the second reference signal resource subset is 45 degrees, the second dimensional direction angle of the third reference signal resource subset is 0 degrees, the second dimensional direction angle of the fourth reference signal resource subset is −45 degrees, and the second dimensional direction angle of the fifth reference signal resource subset is −90 degrees.

On the basis of the embodiment shown in FIG. 2, the beam information includes parameter information of the at least one reference signal resource. The parameter information includes at least one of the following items.

### (1) Beam Identifier Corresponding to Each Reference Signal Resource.

Each reference signal resource corresponds to a beam, and each beam can be indicated by an identifier. For example, a beam identifier corresponding to a reference signal resource is an ID of the beam.

### (2) Total Number of Beams Corresponding to all Reference Signal Resources.

It should be noted that in the embodiment of the present application, it refers to the beam information used by the second device for sending the reference signal.

### (3) First Dimensional Direction Angle Corresponding to Each Reference Signal Resource.

In the embodiment of the present application, each reference signal resource corresponds to a first dimensional direction angle that has a value, and the beam information includes the first dimensional direction angle corresponding to each reference signal resource.

### (4) Second Dimensional Direction Angle Corresponding to Each Reference Signal Resource.

In the embodiment of the present application, each reference signal resource corresponds to a second dimensional direction angle that has a value, and the beam information includes the second dimensional direction angle corresponding to each reference signal resource.

### (5) Number of the First Dimensional Direction Angles.

In the embodiment of the present application, the number of the first dimensional direction angles is used when the second device sends the reference signals. That is, the number of first dimensional direction angles having different values is used by the second device. The first dimensional direction angle is a first dimensional direction angle corresponding to a transmitting beam of the second device. The second device can indicate the number of first dimensional direction angles used, to facilitate the first device to determine the number of first dimensional direction angles used by the second device, and furthermore, the first device can determine a value for each first dimensional direction angle based on the number of first dimensional direction angles.

In some embodiments, after determining the number of first dimensional directional angles, a value for each first dimensional directional angle can be determined based on the range of the first dimensional directional angles and the number of first dimensional directional angles.

Optionally, the number of the first dimensional directional angles is obtained, and then a range of the first dimensional directional angles is obtained to determine an angular interval between two adjacent first dimensional directional angles, and finally a value for each first dimensional directional angle is determined based on the angular interval.

For example, if the range of the first dimensional direction angles is from −90 degrees to 90 degrees and the number of the first dimensional direction angles is five, it is determined that the angular interval between two adjacent first dimensional direction angles is 45 degrees. Specifically, the angle of the first one of the first dimensional direction angles is 90 degrees, the angle of the second one of the first dimensional direction angles is 45 degrees, the angle of the third one of the first dimensional direction angles is 0 degrees, the angle of the fourth one of the first dimensional direction angles is −45 degrees, and the fifth one of the first dimensional direction angles is −90 degrees.

It should be noted that the range of the first dimensional direction angles in the embodiment of the present application is included in the beam information, or, alternatively, the range of the first dimensional direction angles is specified by the protocol, which is not limited in the embodiment of the present application.

### (6) Number of the Second Dimensional Direction Angles.

In the embodiment of the present application, the number of second dimensional direction angles is used when the second device sends the reference signals. The second dimensional direction angle is a second dimensional direction angle corresponding to a transmitting beam of the second device. The second device can indicate the number of second dimensional direction angles used, to facilitate the first device to determine the number of second dimensional direction angles used by the second device, and furthermore, the first device can determine a value for each second dimensional direction angle based on the number of second dimensional direction angles.

In some embodiments, after determining the number of second dimensional directional angles, a value for each second dimensional directional angle can be determined based on the range of the second dimensional directional angles and the number of second dimensional directional angles.

Optionally, the number of the second dimensional directional angles is obtained, and then a range of the second dimensional directional angles is obtained to determine an angular interval between two adjacent second dimensional directional angles, and finally a value for each second dimensional directional angle is determined based on the angular interval.

For example, if the range of the second dimensional direction angles is from 0 degrees to 90 degrees and the number of the second dimensional direction angles is 4, it is determined that the angular interval between two adjacent second dimensional direction angles is 30 degrees. Specifically, the angle of the first one of the second dimensional direction angles is 0 degrees, the angle of the second one of the second dimensional direction angles is 30 degrees, the angle of the third one of the second dimensional direction angles is 60 degrees, and the angle of the fourth one of the second dimensional direction angles is 90 degrees.

It should be noted that the range of the second dimensional direction angles in the embodiment of the present application is included in the beam information, or, alternatively, the range of the second dimensional direction angles is specified by the protocol, which is not limited in the embodiment of the present application.

In addition, there is an implicit correspondence between the first dimensional direction angle and the transmitting beam in the embodiment of the present application. That is, after the second device indicates the value of the first dimensional direction angle or the identifier of the first dimensional direction angle, based on the value of the first dimensional direction angle or the identifier of the first dimensional direction angle, the first device can determine the identifier of the corresponding transmitting beam. The first device may subsequently predict the signal quality of the unmeasured other reference signal(s) based on the determined identifier of the transmitting beam and the signal quality prediction model.

Moreover, there is an implicit correspondence between the second dimensional direction angle and the transmitting beam in the embodiment of the present application. That is, after the second device indicates the value of the second dimensional direction angle or the identifier of the second dimensional direction angle, based on the value of the second dimensional direction angle or the identifier of the second dimensional direction angle, the first device can determine the identifier of the corresponding transmitting beam. The first device may subsequently predict the signal quality of the unmeasured other reference signal(s) based on the determined identifier of the transmitting beam and the signal quality prediction model.

It should be noted that the first dimensional direction angle in the embodiment of the present application is a horizontal direction angle and the second dimensional direction angle is a vertical direction angle, or, the first dimensional direction angle is a vertical direction angle and the second dimensional direction angle is a horizontal direction angle.

For example, for the Global Coordinate System (GCS), a horizontal direction angle (i.e., (i.e., an azimuth angle) is determined based on the north of the geographic location, while a vertical direction angle (i.e., an elevation angle) is determined based on the zenith and the horizontal direction, i.e., an elevation of 0 degrees indicates the zenith, and 90 degrees relative to the horizontal direction.

For the Local Coordinate System (LCS), the azimuth angle is determined based on the X-axis of the LCS, and the elevation angle is based on the Z-axis of the LCS, i.e., an elevation of 0 indicates a 0-degree relative to the Z-axis, and a 90-degree angle relative to the X-Y plane.

### (7) Number of Antenna Array Elements in Each Antenna Array.

The antenna array is an antenna array provided in the second device. The antenna array includes antenna array elements and the antenna array elements are arranged in a matrix manner to form the antenna array. Thus, the number of antenna array elements is carried in the beam information to indicate how many antenna array elements form the antenna array.

### (8) Number of Rows of the Antenna Array Elements in Each Antenna Array.

The antenna array elements are arranged in a matrix manner to form an antenna array. The number of rows of the antenna array elements is carried in the beam information to indicate how many rows of antenna array elements form the antenna array.

### (9) Number of Columns of the Antenna Array Elements in Each Antenna Array.

If the antenna array elements are arranged in a matrix manner to form an antenna array, the number of columns of the antenna array elements is carried in the beam information to indicate how many columns of the antenna array elements form the antenna array.

### (10) Row Identifier of an Antenna Array Element in a Corresponding Antenna Array.

In the embodiment of the present application, a row identifier in the antenna array is used to indicate a row position of the antenna array element in the antenna array.

### (11) Column Identifier of an Antenna Array Element in a Corresponding Antenna Array.

In the embodiment of the present application, a column identifier in the antenna array is used to indicate a column position of the antenna array element in the antenna array.

### (12) Spacing Between Adjacent Antenna Array Elements.

In the embodiment of the present application, a plurality of antenna array elements are used to form an antenna array, and for two adjacent antenna array elements, the two antenna array elements have spacing between them, by which a distance between the antenna array elements is indicated.

### (13) Spacing Between Adjacent Antenna Arrays.

In the embodiment of the present application, communication is carried out through a plurality of antenna arrays, and for two adjacent antenna arrays, the two antenna arrays have spacing between them, by which a distance between the antenna arrays is indicated.

### (14) Number of Antenna Arrays.

In the embodiment of the present application, the number of antenna arrays included in the second device is indicated by beam information. For example, the number of antenna arrays is 2, 4 or some other value.

It should be noted that the position of each antenna array in the second device can be determined in the embodiment of the present application by the positions of the antenna array elements in the antenna array, as well as the parameters between the antenna arrays. Since different antenna arrays correspond to different beams, the transmitting beam identifiers can be determined based on the antenna arrays. Subsequently, the first device can, based on the determined transmitting beam identifiers and the signal quality prediction model, predict the signal quality of the unmeasured other reference signal(s). In addition, different spacing between the antenna elements and different spacing between the antenna arrays will affect the antenna gain. After determining the antenna gain based on the above parameters, the first device can subsequently predict the signal quality of the unmeasured other reference signal(s) based on the determined antenna gain and the signal quality prediction model.

On the basis of the embodiment shown in FIG. 2, the beam information is also used to indicate energy of the reference signal resource.

In some embodiments, the beam information includes energy information of the at least one reference signal resource, the energy information indicating energy for each of the at least one reference signal resource.

In the embodiment of the present application, the energy of the reference signal resource is represented by “power”. Additionally, different reference signal resources correspond to different beam directions, which means that the energy of the reference signal resource can also be referred to as the antenna gain in each beam direction.

Optionally, for each reference signal resource of a plurality of reference signal resources, the beam information indicates the energy of a reference signal resource, and the energy information includes the differential value(s) relative to the energy of that reference signal resource. The energy of respective reference signal resources is indicated by the differential values represented by the energy information of the respective reference signal resources.

In the solution provided in the embodiment of the present application, the energy of each reference signal resource is indicated through the beam information, which improves the accuracy of the beam measurement.

It should be noted that the above embodiments can be split into new embodiments or combined with other embodiments to form new embodiments, and the present application does not limit the combinations between embodiments.

FIG. 5 illustrates a flowchart of a method for transmitting information provided by an embodiment of the present application. Referring to FIG. 5, the method includes the following steps.

Step 501, receiving, by a first device, beam information from a second device, where the beam information indicates beam information corresponding to at least one reference signal resource, the at least one reference signal resource including a resource for beam measurement.

In the embodiment of the present application, the second device sends the beam information indicating the at least one reference signal resource to the first device, and then the first device may receive the beam information sent by the second device. In this case, the at least one reference signal resource includes a resource for beam measurement. That is, after the second device sends the beam information to the first device, the first device may determine information related to the reference signal resource of the second device based on the beam information, so as to facilitate the first device to measure at least one reference signal based on the at least one reference signal resource. After determining the signal quality of the at least one reference signal, based on the signal quality of the at least one reference signal obtained from the measurement, and the beam information corresponding to the reference signal resource, the first device may predict the signal quality of the unmeasured reference signal other than the at least one reference signal.

In this embodiment, the second device may send different reference signals to the first device based on the at least one reference signal resource, and the first device measures at least one reference signal based on the at least one reference signal resource to determine qualities of the respective reference signals sent by the second device.

It should be noted that “beam measurement” in the embodiment of the present application means measuring the at least one reference signal to obtain Layer 1 Reference Signal Received Power (L1-RSRP) and/or Layer 1 Signal to Interference plus Noise Ratio (L1-SINR) of the at least one reference signal.

Reference signals include a Synchronization Signal Block (SSB), a Channel State Information Reference Signal (CSI-RS), and a Sounding Reference Signal (SRS). Beam indication is an indication of a Transmission Configuration Indication (TCI) state. The TCI state includes at least one of Quasi Co-Location (QCL) types including QCL Type A, QCL Type B, QCL Type C, and QCL Type D. The QCL type D is reception parameter information, which may be referred to as a beam. Type A, Type B, and Type C each includes at least one of the following related parameters: Doppler shift, Doppler spread, average delay, or delay spread.

In some embodiments, the first device is a terminal and the second device is a network device.

In the embodiment of the present application, when the first device is a terminal and the second device is a network device, the network device sends beam information to the terminal. The terminal receives the beam information to determine the at least one reference signal resource used for the beam measurement and the beam information corresponding to the at least one reference signal resource. The terminal can then measure the signal quality of the at least one reference signal based on the at least one reference signal resource, and predict the signal quality of the unmeasured other reference signal(s), with reference to the beam information sent by the network device and the signal quality of the at least one reference signal that has been measured.

Optionally, the reference signal resource includes a Synchronization Signal Block (SSB) resource or a Channel State Information Reference Signal (CSI-RS) resource.

In the embodiment of the present application, the network device configures a reference signal resource for the terminal, sends an SSB or a CSI-RS to the terminal via the reference signal resource, so as to facilitate the terminal to receive the SSB or the CSI-RS sent by the network device, and conduct a measurement for the SSB or the CSI-RS to obtain the signal quality of at least one reference signal. In addition, the terminal can also predict the signal quality of the unmeasured other reference signal(s) based on the beam information and the signal quality of the at least one reference signal that has been measured.

In other embodiments, the first device is a network device and the second device is a terminal.

In the embodiment of the present application, when the first device is a network device and the second device is a terminal, the terminal sends beam information to the network device. The network device receives the beam information and can determine at least one reference signal resource used for the beam measurement and beam information corresponding to the at least one reference signal resource. The network device can then measure the signal quality of the at least one reference signal based on the at least one reference signal resource, and predict the signal quality of the unmeasured other reference signal(s), with reference to the beam information sent by the terminal and the signal quality of the at least one reference signal that has been measured.

Optionally, the reference signal resource is an SRS resource. In the embodiment of the present application, when the reference signal resource configured by the network device for the terminal is an SRS resource, the terminal may send an SRS to the network device based on the configured reference signal resource, so as to facilitate the network device to measure the SRS, obtain the signal quality of at least one reference signal, and also predict the signal quality of the unmeasured other reference signal(s), based on the beam information and the signal quality of the at least one reference signal that has been measured.

It should be noted that the steps performed by the terminal in the embodiments of the present application may be implemented separately to form a new embodiment, and the steps performed by the network device may be implemented separately to form a new embodiment.

In the solution provided in the present application, the second device sends to the first device the beam information indicating at least one reference signal resource that is used for the beam measurement, so as to facilitate the first device to determine a relationship between the at least one reference signal resource and the corresponding beam, extending the information of the at least one reference signal resource that is sent by the second device. In addition, the first device can also, based on the beam information of the at least one reference signal resource, carry out a quality prediction for the beam measurement, improving the accuracy of the beam measurement.

Hereinafter, a description is provided with respect to how the first device predicts the signal quality of the unmeasured other reference signal(s). The beam information corresponding to the at least one reference signal resource is used for the first device to predict the signal quality of the unmeasured other reference signal(s), based on this beam information and the signal quality of the reference signal(s) of partially referenced signal resources. In other words, the first device measures at least one reference signal based on at least one reference signal resource to obtain the signal quality of the at least one reference signal, and the first device also predicts the signal quality of the unmeasured other reference signal(s), based on the received beam information as well as the signal quality of the at least one reference signal that has been measured.

The predicted signal quality of the unmeasured other reference signal may include the signal quality corresponding to all of the combinations of the receiving beams of the first device and the reference signals; or the signal quality corresponding to a portion of the combinations of the receiving beams of the first device and the reference signals. For example, only the strongest signal quality of each reference signal that can be obtained when each reference signal is received using all the receiving beams is predicted.

In some embodiments, the second device 32 is a network device and the second device 32 sends different reference signals. The first device 31 is a terminal, and the first device 31 uses at least one receiving beam of itself to receive the reference signals sent by the second device respectively. Alternatively, the second device 32 is a terminal and the second device 32 sends different reference signals. The first device 31 is a network device, and the first device 31 uses at least one receiving beam of itself to receive the reference signals sent by the second device respectively.

For example, as shown in FIG. 3, the second device 32 is provided with a transmitting beam 1, a transmitting beam 2, a transmitting beam 3, and a transmitting beam 4, through which a reference signal 1, a reference signal 2, a reference signal 3, and a reference signal 4 are sent, respectively. The first device 31 is provided with a receiving beam 5, a receiving beam 6, a receiving beam 7, and a receiving beam 8, through which the reference signals sent by the second device 32 are received, respectively. That is, the first device 31 can receive the reference signal 1, the reference signal 2, the reference signal 3, and the reference signal 4 sent by the second device 32 through the receiving beam 5. The first device 31 can also receive the reference signal 1, the reference signal 2, the reference signal 3, and the reference signal 4 sent by the second device 32 through the receiving beam 6, and so on. Each receiving beam of the first device 31 will be used to receive the reference signal 1, the reference signal 2, the reference signal 3 and the reference signal 4 sent by the second device 32. In addition, the signal quality of each reference signal received by each receiving beam can be measured. In the above description, the first device 31 measures all of the combinations of the reference signals and the receiving beams. In various embodiments, the first device 31 may measure a portion of the combinations of the reference signals and the receiving beams. After the first device 31 measures the signal quality of the reference signals, it can also predict the signal quality of the unmeasured other reference signal(s), based on the beam information and the combinations of the reference signals and the receiving beams.

In some embodiments, the first device determines the signal quality of the unmeasured reference signal(s) other than the at least one reference signal, based on the signal quality of the at least one reference signal and beam information corresponding to the at least one reference signal resource.

Optionally, the first device sorts signal qualities of the at least one reference signal according to transmitting beam identifiers corresponding to the at least one reference signal resource and/or at least one receiving beam identifier, and determines the signal quality of the unmeasured other reference signal(s) based on the sorted reference signal qualities and a signal quality prediction model.

In the embodiment of the present application, each receiving beam of the first device has a corresponding identifier. When determining the signal quality of the unmeasured other reference signal(s) based on the beam information of the at least one reference signal resource and the signal qualities of the reference signals received through the receiving beams, the first device sorts the signal qualities of the reference signals in accordance with the identifiers of the receiving beams, or, the first device sorts the signal qualities of the reference signals in accordance with the identifiers of the transmitting beams corresponding to the reference signals, or, the first device sorts the signal qualities of the reference signals in accordance with the identifiers of the receiving beams and the identifiers of the transmitting beams corresponding to the reference signals. The sorted signal qualities of the reference signals are subsequently input into the signal quality prediction model to determine the signal quality of unmeasured reference signal(s) other than these reference signals.

For example, the signal qualities of the at least one reference signal are sorted in accordance with the identifiers of the receiving beams of the first device and/or the identifiers of the transmitting beams. After the sorting, a matrix sequence is obtained and is then input into the signal quality prediction model. In this way, the signal quality of the unmeasured other reference signal(s) can be obtained.

It should be noted that in the embodiment of the present application, when sorting the signal qualities of the at least one reference signal, if there is a reference signal whose signal quality has not been measured, the signal quality of this reference signal is set to “0”.

For example, the signal qualities of the reference signals are sorted in accordance with both the identifiers of the receiving beams and the identifiers of the transmitting beams. When the first device is provided with 2 receiving beams and the second device sends 4 reference signals through 4 transmitting beams, the matrix sequence to be input into the signal quality prediction model includes 8 parameters. The 8 parameters form the matrix sequence having 1 column and 8 rows, including the following signal qualities: the signal quality corresponding to the receiving beam 1 of the first device and the transmitting beam 1 of the second device; the signal quality corresponding to the receiving beam 1 of the first device and the transmitting beam 2 of the second device; the signal quality corresponding to the receiving beam 1 of the first device and the transmitting beam 3 of the second device; the signal quality corresponding to the receiving beam 1 of the first device and the transmitting beam 4 of the second device; the signal quality corresponding to the receiving beam 2 of the first device and the transmitting beam 1 of the second device; the signal quality corresponding to the receiving beam 2 of the first device and the transmitting beam 2 of the second device; the signal quality corresponding to the receiving beam 2 of the first device and the transmitting beam 3 of the second device; and the signal quality corresponding to the receiving beam 2 of the first device and the transmitting beam 4 of the second device.

For the matrix input into the signal quality prediction model, the 8 signal qualities in the matrix are set in such a way that: for a combination of a receiving beam and a reference signal whose signal quality has been measured by the first device, the corresponding parameter in the matrix is set to the signal quality of this reference signal; and for a combination of a receiving beam and a reference signal whose signal quality has not been measured by the first device, the corresponding parameter in the matrix is set to “0”. Subsequently, the signal quality prediction model processes the input matrix to obtain an output matrix by which the signal qualities of all reference signals can be determined.

For example, the matrix obtained by the first device after sorting the signal qualities of the reference signals based on the identifiers of the receiving beams and the identifiers of the transmitting beams is:

$$[ \begin{matrix}RSRP \#1 \\ RSRP \#2 \\ RSRP \#3 \\ RSRP \#4 \\ RSRP \#5 \\ RSRP \#6 \\ RSRP \#7 \\ RSRP \#8\end{matrix} ] = [ \begin{matrix}0 \\ RSRP \#2 \\ 0 \\ 0 \\ RSRP \#5 \\ 0 \\ RSRP \#7 \\ RSRP \#8\end{matrix} ] .$$

The obtained matrix is input into the signal quality prediction model, based on which a processed matrix can be output:

$$[ \begin{matrix}RSRP \#1 \\ RSRP \#2 \\ RSRP \#3 \\ RSRP \#4 \\ RSRP \#5 \\ RSRP \#6 \\ RSRP \#7 \\ RSRP \#8\end{matrix} ] .$$

This matrix can represent the signal qualities of the respective reference signals.

Optionally, the first device groups the signal qualities of the at least one reference signal in accordance with the transmitting beam identifiers corresponding to the at least one reference signal resource and/or at least one receiving beam identifier, and based on the grouped signal qualities of the reference signals and the signal quality prediction model, the first device determines the signal quality of the unmeasured other reference signal(s).

In the embodiment of the present application, each receiving beam has a corresponding identifier. When determining the signal quality of the unmeasured other reference signal(s), the signal qualities of the reference signals received through receiving beams are first grouped in accordance with the identifiers of these receiving beams, in order to obtain the signal qualities of the reference signals belonging to the different groups. Based on the grouped signal qualities of the reference signals and the signal quality prediction model, the signal quality of the unmeasured other reference signal(s) is then determined, which has the same beam information as the receiving beam corresponding to at least one reference signal. Alternatively, when determining the signal quality of the unmeasured other reference signal(s), the signal qualities of the reference signals sent through transmitting beams are first grouped in accordance with the identifiers of these transmitting beams, in order to obtain the signal qualities of the reference signals belonging to the different groups. Based on the grouped signal qualities of the reference signals and the signal quality prediction model, the signal quality of the unmeasured other reference signal(s) is then determined, which has the same beam information as the transmitting beam corresponding to the at least one reference signal.

According to the solution provided in the embodiment of the present application, signal qualities corresponding to the same receiving beam are grouped together. Specifically, the following signal qualities are divided into a group: the signal quality corresponding to the receiving beam 1 of the first device and the transmitting beam 1 of the second device; the signal quality corresponding to the receiving beam 1 of the first device and the transmitting beam 2 of the second device; the signal quality corresponding to the receiving beam 1 of the first device and the transmitting beam 3 of the second device; and the signal quality corresponding to the receiving beam 1 of the first device and the transmitting beam 4 of the second device. The following signal qualities are divided into another group: the signal quality corresponding to the receiving beam 2 of the first device and the transmitting beam 1 of the second device; the signal quality corresponding to the receiving beam 2 of the first device and the transmitting beam 2 of the second device; the signal quality corresponding to the receiving beam 2 of the first device and the transmitting beam 3 of the second device; and the signal quality corresponding to the receiving beam 2 of the first device and the transmitting beam 4 of the second device.

The solution of the embodiments of the present application for predicting the signal quality of the reference signal is similar to the above embodiments and will not be repeated herein.

It should be noted that the signal quality prediction model in the embodiments of the present application is stored in advance in the first device. Alternatively, the signal quality prediction model in the embodiments of the present application is stored in a server and sent by the server to the first device. The first device then predicts the signal quality of the reference signal based on the signal quality prediction model.

In some embodiments, the beam information includes information of an associated reference signal resource subset of the at least one reference signal resource.

In the embodiment of the present application, the beam information indicates the at least one reference signal resource for the beam measurement and may also be configured with an associated reference signal resource subset associated with the at least one reference signal resource. Accordingly, the beam information may include information of the associated reference signal resource subset of the at least one reference signal resource, to indicate associated reference signal resources.

For each reference signal resource in the at least one reference signal resource, the reference signal resource is configured with an associated reference signal resource subset. That is, if the at least one reference signal resource includes a plurality of reference signal resources, and each reference signal resource is associated with an associated reference signal resource subset, the plurality of reference signal resources are associated with a plurality of associated reference signal resource subsets.

In some embodiments, information of the associated reference signal resource subset includes an identifier of the associated reference signal resource subset and an identifier of a reference signal resource in the associated reference signal resource subset.

In the embodiments of the present application, since the beam information includes an associated reference signal resource subset associated with the at least one reference signal resource (i.e., the beam information is required to include information indicating the associated reference signal resource subset), the associated reference signal resource subset is indicated by an identifier of the associated reference signal resource subset, and a reference signal resource in each associated reference signal resource subset is indicated by an identifier of the reference signal resource.

For example, identifiers of the associated reference signal resource subsets included in the beam information are: an associated reference signal resource subset A, an associated reference signal resource subset B, and an associated reference signal resource subset C. In addition, the associated reference signal resource subset A includes an associated reference signal resource 1, an associated reference signal resource 2, and an associated reference signal resource 3. The associated reference signal resource subset B includes an associated reference signal resource 4 and an associated reference signal resource 5. The associated reference signal resource subset C includes an associated reference signal resource 6.

Optionally, the associated reference signal resource subset includes a reference signal resource that is in a same set of reference signal resources as the at least one reference signal resource.

In the embodiment of the present application, the at least one reference signal resource is associated with one or more associated reference signal resource subsets, and each associated reference signal resource subset includes at least one reference signal resource. The associated reference signal resource subset includes a reference signal resource that is in a same set of reference signal resources as the at least one reference signal resource.

Optionally, the associated reference signal resource subset includes a reference signal resource that is in a different set of reference signal resources from the at least one reference signal resource.

In the embodiment of the present application, the at least one reference signal resource is associated with one or more associated reference signal resource subsets, and each associated reference signal resource subset includes at least one reference signal resource. The associated reference signal resource subset includes a reference signal resource that is in a different set of reference signal resources from the at least one reference signal resource.

That is, for the configured associated reference signal resource subsets associated with the at least one reference signal resource, the reference signal resources included in these associated reference signal resource subsets may belong to the same set of reference signal resources as the at least one reference signal resource, or may not belong to the same set of reference signal resources as the at least one reference signal resource, which is not limited in the embodiments of the present application. In other words, for a reference signal resource and an associated reference signal resource subset having an association relationship, the reference signal resource and the associated reference signal resource subset may belong to the same set of reference signal resources, or the reference signal resource and the associated reference signal resource subset may belong to different sets of reference signal resources.

Optionally, the associated reference signal resource subset includes a reference signal resource having a beam direction within a range of a beam direction of the at least one reference signal resource.

In the embodiment of the present application, each reference signal resource has a corresponding beam direction. For the above-mentioned at least one reference signal resource, the range of the beam direction of the at least one reference signal resource covers a beam direction of a reference signal resource included in the associated reference signal resource subset. That is, the beam of the at least one reference signal resource is wide, and the beam corresponding to the reference signal resource included in the associated reference signal resource subset is narrower. Thus, the associated reference signal resource subset includes a reference signal resource having a beam direction within a range of a beam direction of the at least one reference signal resource.

For example, referring to FIG. 4, a range of a beam direction of a beam 1 corresponding to a reference signal resource 1 is large. Beam directions of a beam 2 of a reference signal resource 2, a beam 3 of a reference signal resource 3, and a beam 4 of a reference signal resource 4 included in the associated reference signal resource subset associated with the reference signal resource 1 are all within the range of the beam direction of the beam 1.

It should to be noted that if the associated reference signal resource subset in the embodiment of the present application includes a reference signal resource whose beam direction is within a range of a beam direction of the at least one reference signal resource, when predicting the signal quality of the unmeasured other reference signal(s) based on the signal quality of the at least one reference signal as well as the at least one reference signal resource, the signal quality of the reference signal of at least one reference signal resource in the associated reference signal resource subset can be predicted according to the reference signal quality of the reference signal resource with a larger beam direction range.

For example, referring to FIG. 4, if the associated reference signal resource subset associated with the reference signal resource 1 includes three reference signal resources, namely, the reference signal resource 2, the reference signal resource 3, and the reference signal resource 4, and the beam directions of the reference signal resource 2, the reference signal resource 3, and the reference signal resource 4 fall within the range of the beam direction of the reference signal resource 1, the signal qualities of the reference signals of the reference signal resource 2, the reference signal resource 3, and the reference signal resource 4 included in the associated reference signal resource subset can be output, based on the signal quality prediction model and the input signal quality of the reference signal of the reference signal resource 1.

Optionally, the associated reference signal resource subset includes a reference signal resource having a beam direction adjacent to a beam direction of the at least one reference signal resource.

The beam directions are adjacent, which means that the beam directions of two reference signal resources are in an adjacency relationship. For example, referring to FIG. 4, the beam directions of the reference signal resources include a beam direction 2, a beam direction 3, and a beam direction 4, where the beam direction 2 and the beam direction 3 are in an adjacency relationship, and the beam direction 3 and the beam direction 4 are in an adjacency relationship. That is, when reference signal resources included in the associated reference signal resource subset have beam directions including the beam direction 2, the beam direction 3, and the beam direction 4, and a beam direction of the above-described at least one reference signal resource is the beam direction 3, it is indicated that the associated reference signal resource subset includes a reference signal resource having a beam direction adjacent to a beam direction of the at least one reference signal resource.

In the embodiment of the present application, for the configuration of associated reference signal resources associated with the at least one reference signal resource, the beam directions of these associated reference signal resources may be within the range of the beam direction of the at least one reference signal resource, or may not be within the range of the beam direction of the at least one reference signal resource, which is not limited in the embodiment of the present application.

Additionally, for the associated reference signal resource subset, a first dimensional direction angle and a second dimensional direction angle are also different from those of the at least one reference signal resource.

In some embodiments, the associated reference signal resource subset includes a reference signal resource having a first dimensional direction angle within a range of first dimensional direction angles of the at least one reference signal resource, and/or, the associated reference signal resource subset includes a reference signal resource having a second dimensional direction angle within a range of second dimensional direction angles of the at least one reference signal resource.

It should be noted that the first dimensional direction angle of the reference signal resource in the embodiments of the present application refers to the first dimensional direction angle of the beam corresponding to the reference signal resource. That is, “the first dimensional direction angle of the reference signal resource” in the embodiments of the present application can also be referred to as “the first dimensional direction angle of the beam corresponding to the reference signal resource”. The second dimensional direction angle of the reference signal resource in the embodiments of the present application refers to the second dimensional direction angle of the beam corresponding to the reference signal resource. That is, “the second dimensional direction angle of the reference signal resource” in the embodiments of the present application can also be referred to as “the second dimensional direction angle of the beam corresponding to the reference signal resource”.

In the embodiment of this application, there are three main situations included.

Situation 1: the associated reference signal resource subset includes a reference signal resource having a first dimensional direction angle within a range of first dimensional direction angles of the at least one reference signal resource.

For example, if a range of the first dimensional direction angle(s) of the at least one reference signal resource is from 0 degrees to 120 degrees, all of the first dimensional direction angle(s) of the reference signal resource(s) included in the associated reference signal resource subset lie in the range of 0-120 degrees.

For example, if the associated reference signal resource subset includes a reference signal resource 1, a reference signal resource 2, and a reference signal resource 3, and the reference signal resource 1 has a first dimensional direction angle of 30 degrees, the reference signal resource 2 has a first dimensional direction angle of 60 degrees, and the reference signal resource 3 has a first dimensional direction angle of 90 degrees, it is indicated that the first dimensional direction angles of the three reference signal resources included in the associated reference signal resource subset all fall within the range of the first dimensional direction angle(s) of at least one reference signal resource.

Situation 2: the associated reference signal resource subset includes a reference signal resource having a second dimensional direction angle within a range of second dimensional direction angles of the at least one reference signal resource.

For example, if a range of the second dimensional direction angle(s) of the at least one reference signal resource is from 0 degrees to 120 degrees, all of the second dimensional direction angle(s) of the reference signal resource(s) included in the associated reference signal resource subset lie in the range of 0-120 degrees.

For example, if the associated reference signal resource subset includes a reference signal resource 1, a reference signal resource 2, and a reference signal resource 3, and the reference signal resource 1 has a second dimensional direction angle of 30 degrees, the reference signal resource 2 has a second dimensional direction angle of 60 degrees, and the reference signal resource 3 has a second dimensional direction angle of 90 degrees, it is indicated that the second dimensional direction angles of the three reference signal resources included in the associated reference signal resource subset all fall within the range of the second dimensional direction angle(s) of at least one reference signal resource.

Situation 3: the associated reference signal resource subset includes a reference signal resource having a first dimensional direction angle within a range of first dimensional direction angles of the at least one reference signal resource; and the associated reference signal resource subset includes a reference signal resource having a second dimensional direction angle within a range of second dimensional direction angles of the at least one reference signal resource.

The situation 3 in the embodiment of the present application is similar to the above two situations in the embodiments and will not be repeated herein.

Optionally, the associated reference signal resource subset includes a reference signal resource having a first dimensional direction angle adjacent to a first dimensional direction angle of the at least one reference signal resource, and/or, the associated reference signal resource subset includes a reference signal resource having a second dimensional direction angle adjacent to a second dimensional direction angle of the at least one reference signal resource.

In the embodiment of this application, there are three main situations included.

Situation 1: the associated reference signal resource subset includes a reference signal resource having a first dimensional direction angle adjacent to a first dimensional direction angle of the at least one reference signal resource.

First dimensional direction angles are adjacent, which means that the first dimensional direction angles of two reference signal resources are adjacent. For example, if the first dimensional direction angles include 0 degrees, 30 degrees, 60 degrees, and 90 degrees, 0 degrees and 30 degrees are adjacent, 30 degrees and 60 degrees are adjacent, and 60 degrees and 90 degrees are adjacent.

For example, the reference signal resources included in the associated reference signal resource subset all have a first dimensional direction angle of 30 degrees, and the at least one reference signal resource has a first dimensional direction angle of 60 degrees, which indicates that the associated reference signal resource subset includes a reference signal resource having a first dimensional direction angle adjacent to a first dimensional direction angle of the at least one reference signal resource.

Situation 2: the associated reference signal resource subset includes a reference signal resource having a second dimensional direction angle adjacent to a second dimensional direction angle of the at least one reference signal resource.

Second dimensional direction angles are adjacent, which means that the second dimensional direction angles of two reference signal resources are adjacent. For example, if the second dimensional direction angles include 0 degrees, 40 degrees, 80 degrees, and 120 degrees, 0 degrees and 40 degrees are adjacent, 40 degrees and 80 degrees are adjacent, and 80 degrees and 120 degrees are adjacent.

For example, the reference signal resources included in the associated reference signal resource subset all have a second dimensional direction angle of 80 degrees, and the at least one reference signal resource has a second dimensional direction angle of 40 degrees, which indicates that the associated reference signal resource subset includes a reference signal resource having a second dimensional direction angle adjacent to a second dimensional direction angle of the at least one reference signal resource.

Situation 3: the associated reference signal resource subset includes a reference signal resource having a first dimensional direction angle adjacent to a first dimensional direction angle of the at least one reference signal resource, and the associated reference signal resource subset includes a reference signal resource having a second dimensional direction angle adjacent to a second dimensional direction angle of the at least one reference signal resource.

In some embodiments, the beam information includes a reference signal resource subset to which the at least one reference signal resource belongs.

In the embodiments of the present application, each reference signal resource in the at least one reference signal resource has a reference signal resource subset to which it belongs. By means of the at least one reference signal resource, the beam information also includes the reference signal resource subset to which the at least one reference signal resource belongs, so that the reference signal resource subset can also be indicated through the beam information.

For example, the beam information includes an identifier of a reference signal resource subset to which each of the at least one reference signal resource belongs.

For example, the at least one reference signal resource includes: a reference signal resource 1, a reference signal resource 2, and a reference signal resource 3, the reference signal resource 1 and the reference signal resource 2 belonging to a reference signal resource subset 1, and the reference signal resource 3 belonging to a reference signal resource subset 2.

Optionally, beams of all reference signal resources in the reference signal resource subset are adjacent to each other in direction.

In the embodiment of the present application, beams of all reference signal resources in the reference signal resource subset are adjacent to each other in direction, which means that the beam direction of each reference signal resource is narrower and does not cover the beam direction of other reference signal resources.

The beams of all reference signal resources in the reference signal resource subset are adjacent to each other in direction, similar to the beams of all reference signal resources in the associated reference signal resource subset in the above embodiments, which will not be repeated herein.

Optionally, reference signal resources in the reference signal resource subset have a same first dimensional direction angle, and the reference signal resources in the reference signal resource subset have different second dimensional direction angles.

For example, the reference signal resource subset includes a reference signal resource 1, a reference signal resource 2, a reference signal resource 3, and a reference signal resource 4, which all correspond to a first dimensional direction angle of 30 degrees, while the reference signal resource 1 corresponds to a second dimensional direction angle of angle 1, the reference signal resource 2 corresponds to a second dimensional direction angle of angle 2, the reference signal resource 3 corresponds to a second dimensional direction angle of angle 3, and the reference signal resource 4 corresponds to a second dimensional direction angle of angle 4.

In some embodiments, when at least two reference signal resource subsets exist, the at least two reference signal resource subsets correspond to different first dimensional direction angles.

For example, a reference signal resource subset 1 corresponds to a first dimensional direction angle of 30 degrees, a reference signal resource subset 2 corresponds to a first dimensional direction angle of 60 degrees, a reference signal resource subset 3 corresponds to a first dimensional direction angle of 90 degrees, and a reference signal resource subset 4 corresponds to a first dimensional direction angle of 120 degrees.

In the embodiment of the present application, each reference signal resource has a corresponding beam direction. For the above-described at least one reference signal resource, the beam direction of the at least one reference signal resource is adjacent to the beam direction of the reference signal resource included in the associated reference signal resource subset. That is, the beam direction of the at least one reference signal resource does not cover the beam direction of the reference signal resource included in the associated reference signal resource subset, and the beam direction of the at least one reference signal resource and the beam direction of the associated reference signal resource subset are both narrower, thus forming a beam adjacency relationship.

For example, the at least one reference signal resource is associated with four associated reference signal resource subsets, each associated reference signal resource subset includes four reference signal resources, and the four reference signal resources correspond to different second dimensional direction angles.

The reference signal resource subset 1 includes a reference signal resource 1, a reference signal resource 2, a reference signal resource 3, and a reference signal resource 4, which all correspond to a first dimensional direction angle of 30 degrees, and the reference signal resource 1 corresponds to a second dimensional direction angle of angle 1, the reference signal resource 2 corresponds to a second dimensional direction angle of angle 2, the reference signal resource 3 corresponds to a second dimensional direction angle of angle 3, and the reference signal resource 4 corresponds to a second dimensional direction angle of angle 4.

The reference signal resource subset 2 includes a reference signal resource 5, a reference signal resource 6, a reference signal resource 7, and a reference signal resource 8, which all correspond to a first dimensional direction angle of 60 degrees, while the reference signal resource 5 corresponds to a second dimensional direction angle of angle 1, the reference signal resource 6 corresponds to a second dimensional direction angle of angle 2, the reference signal resource 7 corresponds to a second dimensional direction angle of angle 3, and the reference signal resource 8 corresponds to a second dimensional direction angle of angle 4.

The reference signal resource subset 3 includes a reference signal resource 9, a reference signal resource 10, a reference signal resource 11, and a reference signal resource 12, which all correspond to a first dimensional direction angle of 90 degrees, while the reference signal resource 9 corresponds to a second dimensional direction angle of angle 1, the reference signal resource 10 corresponds to a second dimensional direction angle of angle 2, the reference signal resource 11 corresponds to a second dimensional direction angle of angle 3, and the reference signal resource 12 corresponds to a second dimensional direction angle of angle 4.

The reference signal resource subset 4 includes a reference signal resource 13, a reference signal resource 14, a reference signal resource 15, and a reference signal resource 16, which all correspond to a first dimensional direction angle of 120 degrees, while the reference signal resource 13 corresponds to a second dimensional direction angle of angle 1, the reference signal resource 14 corresponds to a second dimensional direction angle of angle 2, the reference signal resource 15 corresponds to a second dimensional direction angle of angle 3, and the reference signal resource 16 corresponds to a second dimensional direction angle of angle 4.

It should be noted that the first dimensional direction angle of the reference signal resource subset in the above embodiments is proportional to the identifier of the reference signal resource subset. That is, the larger the identifier of the reference signal resource subset is, the larger the first dimensional direction angle of the reference signal resource subset is. In addition, the second dimensional direction angle of the reference signal resource included in the reference signal resource subset is proportional to the identifier of the reference signal resource. That is, the larger the identifier of the reference signal resource in the reference signal resource subset, the larger the second dimensional direction angle of the reference signal resource.

In the embodiment of the present application, if the beam information indicates a range of the first dimensional direction angles of the at least one reference signal resource and also includes the number of reference signal resource subsets, the first dimensional direction angle of the reference signal resource subset may be determined.

Optionally, an angular interval of the first dimensional direction angles between two adjacent reference signal resource subsets is determined based on the range of the first dimensional direction angles and the number of reference signal resource subsets, and then a value of the first dimensional direction angle of each reference signal resource subset is determined based on the angular interval.

For example, if a range of the first dimensional direction angles is from −90 degrees to 90 degrees, and the number of reference signal resource subsets is five, an angular interval of the first dimensional direction angles of two adjacent reference signal resource subsets is determined to be 45 degrees. Specifically, the first dimensional direction angle of the first reference signal resource subset is 90 degrees, the first dimensional direction angle of the second reference signal resource subset is 45 degrees, the first dimensional direction angle of the third reference signal resource subset is 0 degrees, the first dimensional direction angle of the fourth reference signal resource subset is −45 degrees, and the first dimensional direction angle of the fifth reference signal resource subset is −90 degrees.

If the beam information indicates a range of the second dimensional direction angles of the at least one reference signal resource and also includes the number of reference signal resources included in the reference signal resource subset, a second dimensional direction angle of each reference signal resource subset of the reference signal resource subsets can be determined.

Optionally, an angular interval of the second dimensional direction angles between two adjacent reference signal resource subsets is determined based on the range of the second dimensional direction angles and a number of reference signal resource subsets, and then a value of the second dimensional direction angle of each reference signal resource subset is determined based on the angular interval.

For example, if a range of the second dimensional direction angles is from −90 degrees to 90 degrees, and the number of reference signal resource subsets is five, an angular interval of the second dimensional direction angles of two adjacent reference signal resource subsets is determined to be 45 degrees. Specifically, the second dimensional direction angle of the first reference signal resource subset is 90 degrees, the second dimensional direction angle of the second reference signal resource subset is 45 degrees, the second dimensional direction angle of the third reference signal resource subset is 0 degrees, the second dimensional direction angle of the fourth reference signal resource subset is −45 degrees, and the second dimensional direction angle of the fifth reference signal resource subset is −90 degrees.

On the basis of the embodiment shown in FIG. 2, the beam information includes parameter information of the at least one reference signal resource.

The parameter information includes at least one of the following items.

### (1) Beam Identifier Corresponding to Each Reference Signal Resource.

Each reference signal resource corresponds to a beam, and each beam can be indicated by an identifier. For example, a beam identifier corresponding to a reference signal resource is an ID of the beam.

### (2) Total Number of Beams Corresponding to all Reference Signal Resources.

It should be noted that in the embodiment of the present application, it refers to the beam information used by the second device for sending the reference signal.

### (3) First Dimensional Direction Angle Corresponding to Each Reference Signal Resource.

In the embodiment of the present application, each reference signal resource corresponds to a first dimensional direction angle that has a value, and the beam information includes the first dimensional direction angle corresponding to each reference signal resource.

### (4) Second Dimensional Direction Angle Corresponding to Each Reference Signal Resource.

In the embodiment of the present application, each reference signal resource corresponds to a second dimensional direction angle that has a value, and the beam information includes the second dimensional direction angle corresponding to each reference signal resource.

### (5) Number of the First Dimensional Direction Angles.

In the embodiment of the present application, the number of the first dimensional direction angles is used when the second device sends the reference signals. That is, the number of first dimensional direction angles having different values is used by the second device. The first dimensional direction angle is a first dimensional direction angle corresponding to a transmitting beam of the second device. The second device can indicate the number of first dimensional direction angles used, to facilitate the first device to determine the number of first dimensional direction angles used by the second device, and furthermore, the first device can determine a value for each first dimensional direction angle based on the number of first dimensional direction angles.

In some embodiments, after determining the number of first dimensional directional angles, a value for each first dimensional directional angle can be determined based on the range of the first dimensional directional angles and the number of first dimensional directional angles.

Optionally, the number of the first dimensional directional angles is obtained, and then a range of the first dimensional directional angles is obtained to determine an angular interval between two adjacent first dimensional directional angles, and finally a value for each first dimensional directional angle is determined based on the angular interval.

For example, if the range of the first dimensional direction angles is from −90 degrees to 90 degrees and the number of the first dimensional direction angles is five, it is determined that the angular interval between two adjacent first dimensional direction angles is 45 degrees. Specifically, the angle of the first one of the first dimensional direction angles is 90 degrees, the angle of the second one of the first dimensional direction angles is 45 degrees, the angle of the third one of the first dimensional direction angles is 0 degrees, the angle of the fourth one of the first dimensional direction angles is −45 degrees, and the fifth one of the first dimensional direction angles is −90 degrees.

It should be noted that the range of the first dimensional direction angles in the embodiment of the present application is included in the beam information, or, alternatively, the range of the first dimensional direction angles is specified by the protocol, which is not limited in the embodiment of the present application.

### (6) Number of the Second Dimensional Direction Angles.

In the embodiment of the present application, the second device indicates the number of second dimensional direction angles, that is, the number of second dimensional direction angles having different values used by the second device. Here, the second dimensional direction angle is a second dimensional direction angle corresponding to a transmitting beam of the second device.

The second device can indicate the number of second dimensional direction angles used, to facilitate the first device to determine the number of second dimensional direction angles used by the second device, and furthermore, the first device can determine a value for each second dimensional direction angle based on the number of second dimensional direction angles.

In some embodiments, after determining the number of second dimensional directional angles, a value for each second dimensional directional angle can be determined based on the range of the second dimensional directional angles and the number of second dimensional directional angles.

Optionally, the number of the second dimensional directional angles is obtained, and then a range of the second dimensional directional angles is obtained to determine an angular interval between two adjacent second dimensional directional angles, and finally a value for each second dimensional directional angle is determined based on the angular interval.

For example, if the range of the second dimensional direction angles is from 0 degrees to 90 degrees and the number of the second dimensional direction angles is 4, it is determined that the angular interval between two adjacent second dimensional direction angles is 30 degrees. Specifically, the angle of the first one of the second dimensional direction angles is 0 degrees, the angle of the second one of the second dimensional direction angles is 30 degrees, the angle of the third one of the second dimensional direction angles is 60 degrees, the angle of the fourth one of the second dimensional direction angles is 90 degrees.

It should be noted that the range of the second dimensional direction angles in the embodiment of the present application is included in the beam information, or, alternatively, the range of the second dimensional direction angles is specified by the protocol, which is not limited in the embodiment of the present application.

In addition, there is an implicit correspondence between the first dimensional direction angle and the transmitting beam in the embodiment of the present application. That is, after the second device indicates the value of the first dimensional direction angle or the identifier of the first dimensional direction angle, based on the value of the first dimensional direction angle or the identifier of the first dimensional direction angle, the first device can determine the identifier of the corresponding transmitting beam. The first device may subsequently predict the signal quality of the unmeasured other reference signal(s) based on the determined identifier of the transmitting beam and the signal quality prediction model.

Moreover, there is an implicit correspondence between the second dimensional direction angle and the transmitting beam in the embodiment of the present application. That is, after the second device indicates the value of the second dimensional direction angle or the identifier of the second dimensional direction angle, based on the value of the second dimensional direction angle or the identifier of the second dimensional direction angle, the first device can determine the identifier of the corresponding transmitting beam. The first device may subsequently predict the signal quality of the unmeasured other reference signal(s) based on the determined identifier of the transmitting beam and the signal quality prediction model.

It should be noted that the first dimensional direction angle in the embodiment of the present application is a horizontal direction angle and the second dimensional direction angle is a vertical direction angle, or, the first dimensional direction angle is a vertical direction angle and the second dimensional direction angle is a horizontal direction angle.

For example, for the Global Coordinate System (GCS), a horizontal direction angle (i.e., an azimuth angle) is determined based on the north of the geographic location, while a vertical direction angle (i.e., an elevation angle) is determined based on the zenith and the horizontal direction, i.e., an elevation of 0 degrees indicates the zenith, and 90 degrees relative to the horizontal direction.

For the Local Coordinate System (LCS), the azimuth angle is determined based on the X-axis of the LCS, and the elevation angle is based on the Z-axis of the LCS, i.e., an elevation of 0 indicates a 0-degree relative to the Z-axis, and a 90-degree angle relative to the X-Y plane.

### (7) Number of Antenna Array Elements in Each Antenna Array.

The antenna array is an antenna array provided in the second device. The antenna array includes antenna array elements and the antenna array elements are arranged in a matrix manner to form the antenna array. Thus, the number of antenna array elements is carried in the beam information to indicate how many antenna array elements form the antenna array.

### (8) Number of Rows of the Antenna Array Elements in Each Antenna Array.

The antenna array elements are arranged in a matrix manner to form an antenna array. The number of rows of the antenna array elements is carried in the beam information to indicate how many rows of antenna array elements form the antenna array.

### (9) Number of Columns of the Antenna Array Elements in Each Antenna Array.

If the antenna array elements are arranged in a matrix manner to form an antenna array, the number of columns of the antenna array elements is carried in the beam information to indicate how many columns of the antenna array elements form the antenna array.

### (10) Row Identifier of an Antenna Array Element in a Corresponding Antenna Array.

In the embodiment of the present application, a row identifier in the antenna array is used to indicate a row position of the antenna array element in the antenna array.

### (11) Column Identifier of an Antenna Array Element in a Corresponding Antenna Array.

In the embodiment of the present application, a column identifier in the antenna array is used to indicate a column position of the antenna array element in the antenna array.

### (12) Spacing Between Adjacent Antenna Array Elements.

In the embodiment of the present application, a plurality of antenna array elements are used to form an antenna array, and for two adjacent antenna array elements, the two antenna array elements have spacing between them, by which a distance between the antenna array elements is indicated.

### (13) Spacing Between Adjacent Antenna Arrays.

In the embodiment of the present application, communication is carried out through a plurality of antenna arrays, and for two adjacent antenna arrays, the two antenna arrays have spacing between them, by which a distance between the antenna arrays is indicated.

### (14) Number of Antenna Arrays.

In the embodiment of the present application, the number of antenna arrays included in the second device is indicated by beam information. For example, the number of antenna arrays is 2, 4 or some other value.

In some embodiments, the beam information includes energy information of the at least one reference signal resource, the energy information indicating energy for each of the at least one reference signal resource.

It should be noted that the position of each antenna array in the second device can be determined in the embodiment of the present application by the positions of the antenna array elements in the antenna array, as well as the parameters between the antenna arrays. Since different antenna arrays correspond to different beams, the transmitting beam identifiers can be determined based on the antenna arrays. Subsequently, the first device can, based on the determined transmitting beam identifiers and the signal quality prediction model, predict the signal quality of the unmeasured other reference signal(s). In addition, different spacing between the antenna elements and different spacing between the antenna arrays will affect the antenna gain. After determining the antenna gain based on the above parameters, the first device can subsequently predict the signal quality of the unmeasured other reference signal(s) based on the determined antenna gain and the signal quality prediction model.

In the embodiment of the present application, the energy of the reference signal resource is represented by “power”. Additionally, different reference signal resources correspond to different beam directions, which means that the energy of the reference signal resource can also be referred to as the antenna gain in each beam direction.

Optionally, for each reference signal resource of a plurality of reference signal resources, the beam information indicates the energy of a reference signal resource, and the energy information includes the differential value(s) relative to the energy of that reference signal resource. The energy of respective reference signal resources is indicated by the differential values represented by the energy information of the respective reference signal resources.

It should be noted that the steps performed in the embodiment of the present application are similar to the steps performed in the embodiment described above and will not be repeated herein.

FIG. 6 illustrates a flowchart of a method for transmitting information provided by an embodiment of the present application. Referring to FIG. 6, the method includes the following steps.

Step 601, sending, by a second device, beam information to a first device, where the beam information indicates beam information corresponding to at least one reference signal resource, the at least one reference signal resource including a resource for beam measurement.

In the embodiment of the present application, the second device sends the beam information indicating the at least one reference signal resource to the first device, and then the first device may receive the beam information sent by the second device. In this case, the at least one reference signal resource includes a resource for beam measurement. That is, after the second device sends the beam information to the first device, the first device may determine information related to the reference signal resource of the second device based on the beam information, so as to facilitate the first device to measure at least one reference signal based on the at least one reference signal resource. After determining the signal quality of the at least one reference signal, based on the signal quality of the at least one reference signal obtained from the measurement, and the beam information corresponding to the reference signal resource, the first device may predict the signal quality of the unmeasured reference signal other than the at least one reference signal.

In this embodiment, the second device may send different reference signals to the first device based on the at least one reference signal resource, and the first device measures the reference signals based on the at least one reference signal resource to determine qualities of the respective reference signals sent by the second device.

It should be noted that “beam measurement” in the embodiment of the present application means measuring the at least one reference signal to obtain Layer 1 Reference Signal Received Power (L1-RSRP) and/or Layer 1 Signal to Interference plus Noise Ratio (L1-SINR) of the at least one reference signal.

Reference signals include a Synchronization Signal Block (SSB), a Channel State Information Reference Signal (CSI-RS), and a Sounding Reference Signal (SRS). Beam indication is an indication of a Transmission Configuration Indication (TCI) state. The TCI state includes at least one of Quasi Co-Location (QCL) types including QCL Type A, QCL Type B, QCL Type C, and QCL Type D. The QCL type D is reception parameter information, which may be referred to as a beam. Type A, Type B, and Type C each includes at least one of the following related parameters: Doppler shift, Doppler spread, average delay, or delay spread.

In some embodiments, the first device is a terminal and the second device is a network device.

In the embodiment of the present application, when the first device is a terminal and the second device is a network device, the network device sends beam information to the terminal. The terminal receives the beam information to determine the at least one reference signal resource used for the beam measurement and the beam information corresponding to the at least one reference signal resource. The terminal can then measure the signal quality of the at least one reference signal based on the at least one reference signal resource, and predict the signal quality of the unmeasured other reference signal(s), with reference to the beam information sent by the network device and the signal quality of the at least one reference signal that has been measured.

Optionally, the reference signal resource includes a Synchronization Signal Block (SSB) resource or a Channel State Information Reference Signal (CSI-RS) resource.

In the embodiment of the present application, the network device configures a reference signal resource for the terminal, sends an SSB or a CSI-RS to the terminal via the reference signal resource, so as to facilitate the terminal to receive the SSB or the CSI-RS sent by the network device, and conduct a measurement for the SSB or the CSI-RS to obtain the signal quality of at least one reference signal. In addition, the terminal can also predict the signal quality of the unmeasured other reference signal(s) based on the beam information and the signal quality of the at least one reference signal that has been measured.

In other embodiments, the first device is a network device and the second device is a terminal.

In the embodiment of the present application, when the first device is a network device and the second device is a terminal, the terminal sends beam information to the network device. The network device receives the beam information and can determine at least one reference signal resource used for the beam measurement and beam information corresponding to the at least one reference signal resource. The network device can then measure the signal quality of the at least one reference signal based on the at least one reference signal resource, and predict the signal quality of the unmeasured other reference signal(s), with reference to the beam information sent by the terminal and the signal quality of the reference signal that has been measured.

Optionally, the reference signal resource is an SRS resource. In the embodiment of the present application, when the reference signal resource configured by the network device for the terminal is an SRS resource, the terminal may send an SRS to the network device based on the configured reference signal resource, so as to facilitate the network device to measure the SRS, obtain the signal quality of the reference signal, and also predict the signal quality of the unmeasured other reference signal(s), based on the beam information and the signal quality of the reference signal that has been measured.

In some embodiments, the beam information includes information of an associated reference signal resource subset of the at least one reference signal resource.

In the embodiments of the present application, the beam information indicates the at least one reference signal resource for the beam measurement and may also be configured with reference signal resource(s) associated with the at least one reference signal resource. Accordingly, the beam information may include information of the associated reference signal resource subset of the at least one reference signal resource, to indicate the associated reference signal resource(s).

For each reference signal resource in the at least one reference signal resource, the reference signal resource is configured with an associated reference signal resource subset. That is, if the at least one reference signal resource includes a plurality of reference signal resources, and each reference signal resource is associated with an associated reference signal resource subset, the plurality of reference signal resources are associated with a plurality of associated reference signal resource subsets.

In some embodiments, information of the associated reference signal resource subset includes an identifier of the associated reference signal resource subset and an identifier of a reference signal resource in the associated reference signal resource subset.

In the embodiments of the present application, since the beam information includes an associated reference signal resource subset associated with the at least one reference signal resource (i.e., the beam information is required to include information indicating the associated reference signal resource subset), the associated reference signal resource subset is indicated by an identifier of the associated reference signal resource subset, and a reference signal resource in each associated reference signal resource subset is indicated by an identifier of the reference signal resource.

For example, identifiers of the associated reference signal resource subsets included in the beam information are: an associated reference signal resource subset A, an associated reference signal resource subset B, and an associated reference signal resource subset C. In addition, the associated reference signal resource subset A includes an associated reference signal resource 1, an associated reference signal resource 2, and an associated reference signal resource 3. The associated reference signal resource subset B includes an associated reference signal resource 4 and an associated reference signal resource 5. The associated reference signal resource subset C includes an associated reference signal resource 6.

Optionally, the associated reference signal resource subset includes a reference signal resource that is in a same set of reference signal resources as the at least one reference signal resource.

In the embodiment of the present application, the at least one reference signal resource is associated with one or more associated reference signal resource subsets, and each associated reference signal resource subset includes at least one reference signal resource. The associated reference signal resource subset includes a reference signal resource that is in a same set of reference signal resources as the at least one reference signal resource.

Optionally, the associated reference signal resource subset includes a reference signal resource that is in a different set of reference signal resources from the at least one reference signal resource.

In the embodiment of the present application, the at least one reference signal resource is associated with one or more associated reference signal resource subsets, and each associated reference signal resource subset includes at least one reference signal resource. The associated reference signal resource subset includes a reference signal resource that is in a different set of reference signal resources from the at least one reference signal resource.

That is, for the configured associated reference signal resource subsets associated with the at least one reference signal resource, the reference signal resources included in these associated reference signal resource subsets may belong to the same set of reference signal resources as the at least one reference signal resource, or may not belong to the same set of reference signal resources as the at least one reference signal resource, which is not limited in the embodiments of the present application. In other words, for a reference signal resource and an associated reference signal resource subset having an association relationship, the reference signal resource and the associated reference signal resource subset may belong to the same set of reference signal resources, or the reference signal resource and the associated reference signal resource subset may belong to different sets of reference signal resources.

Optionally, the associated reference signal resource subset includes a reference signal resource having a beam direction within a range of a beam direction of the at least one reference signal resource.

In the embodiment of the present application, each reference signal resource has a corresponding beam direction. For the above-mentioned at least one reference signal resource, the range of the beam direction of the at least one reference signal resource covers a beam direction of a reference signal resource included in the associated reference signal resource subset. That is, the beam of the at least one reference signal resource is wide, and the beam corresponding to the reference signal resource included in the associated reference signal resource subset is narrower. Thus, the associated reference signal resource subset includes a reference signal resource having a beam direction within a range of a beam direction of the at least one reference signal resource.

For example, referring to FIG. 4, a range of a beam direction of a beam 1 corresponding to a reference signal resource 1 is large. Beam directions of a beam 2 of a reference signal resource 2, a beam 3 of a reference signal resource 3, and a beam 4 of a reference signal resource 4 included in the associated reference signal resource subset associated with the reference signal resource 1 are all within the range of the beam direction of the beam 1.

Optionally, the associated reference signal resource subset includes a reference signal resource having a beam direction adjacent to a beam direction of the at least one reference signal resource.

The beam directions are adjacent, which means that the beam directions of two reference signal resources are in an adjacency relationship. For example, referring to FIG. 4, the beam directions of the reference signal resources include a beam direction 2, a beam direction 3, and a beam direction 4, where the beam direction 2 and the beam direction 3 are in an adjacency relationship, and the beam direction 3 and the beam direction 4 are in an adjacency relationship. That is, when reference signal resources included in the associated reference signal resource subset have beam directions including the beam direction 2, the beam direction 3, and the beam direction 4, and a beam direction of the above-described at least one reference signal resource is the beam direction 3, it is indicated that the associated reference signal resource subset includes a reference signal resource having a beam direction adjacent to a beam direction of the at least one reference signal resource.

In the embodiment of the present application, for the configuration of associated reference signal resources associated with the at least one reference signal resource, the beam directions of these associated reference signal resources may be within the range of the beam direction of the at least one reference signal resource, or may not be within the range of the beam direction of the at least one reference signal resource, which is not limited in the embodiment of the present application.

Additionally, for the associated reference signal resource subset, a first dimensional direction angle and a second dimensional direction angle are also different from those of the at least one reference signal resource.

In some embodiments, the associated reference signal resource subset includes a reference signal resource having a first dimensional direction angle within a range of first dimensional direction angles of the at least one reference signal resource, and/or, the associated reference signal resource subset includes a reference signal resource having a second dimensional direction angle within a range of second dimensional direction angles of the at least one reference signal resource.

It should be noted that the first dimensional direction angle of the reference signal resource in the embodiments of the present application refers to the first dimensional direction angle of the beam corresponding to the reference signal resource. That is, “the first dimensional direction angle of the reference signal resource” in the embodiments of the present application can also be referred to as “the first dimensional direction angle of the beam corresponding to the reference signal resource”. The second dimensional direction angle of the reference signal resource in the embodiments of the present application refers to the second dimensional direction angle of the beam corresponding to the reference signal resource. That is, “the second dimensional direction angle of the reference signal resource” in the embodiments of the present application can also be referred to as “the second dimensional direction angle of the beam corresponding to the reference signal resource”.

In the embodiment of this application, there are three main situations included.

Situation 1: the associated reference signal resource subset includes a reference signal resource having a first dimensional direction angle within a range of first dimensional direction angles of the at least one reference signal resource.

For example, if a range of the first dimensional direction angle(s) of the at least one reference signal resource is from 0 degrees to 120 degrees, all of the first dimensional direction angle(s) of the reference signal resource(s) included in the associated reference signal resource subset lie in the range of 0-120 degrees.

For example, if the associated reference signal resource subset includes a reference signal resource 1, a reference signal resource 2, and a reference signal resource 3, and the reference signal resource 1 has a first dimensional direction angle of 30 degrees, the reference signal resource 2 has a first dimensional direction angle of 60 degrees, and the reference signal resource 3 has a first dimensional direction angle of 90 degrees, it is indicated that the first dimensional direction angles of the three reference signal resources included in the associated reference signal resource subset all fall within the range of the first dimensional direction angle(s) of at least one reference signal resource.

Situation 2: the associated reference signal resource subset includes a reference signal resource having a second dimensional direction angle within a range of second dimensional direction angles of the at least one reference signal resource.

For example, if a range of the second dimensional direction angle(s) of the at least one reference signal resource is from 0 degrees to 120 degrees, all of the second dimensional direction angle(s) of the reference signal resource(s) included in the associated reference signal resource subset lie in the range of 0-120 degrees.

For example, if the associated reference signal resource subset includes a reference signal resource 1, a reference signal resource 2, and a reference signal resource 3, and the reference signal resource 1 has a second dimensional direction angle of 30 degrees, the reference signal resource 2 has a second dimensional direction angle of 60 degrees, and the reference signal resource 3 has a second dimensional direction angle of 90 degrees, it is indicated that the second dimensional direction angles of the three reference signal resources included in the associated reference signal resource subset all fall within the range of the second dimensional direction angle(s) of at least one reference signal resource.

Situation 3: the associated reference signal resource subset includes a reference signal resource having a first dimensional direction angle within a range of first dimensional direction angles of the at least one reference signal resource; and the associated reference signal resource subset includes a reference signal resource having a second dimensional direction angle within a range of second dimensional direction angles of the at least one reference signal resource.

The situation 3 in the embodiment of the present application is similar to the above two situations in the embodiments and will not be repeated herein.

Optionally, the associated reference signal resource subset includes a reference signal resource having a first dimensional direction angle adjacent to a first dimensional direction angle of the at least one reference signal resource, and/or, the associated reference signal resource subset includes a reference signal resource having a second dimensional direction angle adjacent to a second dimensional direction angle of the at least one reference signal resource.

In the embodiment of this application, there are three main situations included.

Situation 1: the associated reference signal resource subset includes a reference signal resource having a first dimensional direction angle adjacent to a first dimensional direction angle of the at least one reference signal resource.

First dimensional direction angles are adjacent, which means that the first dimensional direction angles of two reference signal resources are adjacent. For example, if the first dimensional direction angles include 0 degrees, 30 degrees, 60 degrees, and 90 degrees, 0 degrees and 30 degrees are adjacent, 30 degrees and 60 degrees are adjacent, and 60 degrees and 90 degrees are adjacent.

For example, the reference signal resources included in the associated reference signal resource subset all have a first dimensional direction angle of 30 degrees, and the at least one reference signal resource has a first dimensional direction angle of 60 degrees, which indicates that the associated reference signal resource subset includes a reference signal resource having a first dimensional direction angle adjacent to a first dimensional direction angle of the at least one reference signal resource.

Situation 2: the associated reference signal resource subset includes a reference signal resource having a second dimensional direction angle adjacent to a second dimensional direction angle of the at least one reference signal resource.

Second dimensional direction angles are adjacent, which means that the second dimensional direction angles of two reference signal resources are adjacent. For example, if the second dimensional direction angles include 0 degrees, 40 degrees, 80 degrees, and 120 degrees, 0 degrees and 40 degrees are adjacent, 40 degrees and 80 degrees are adjacent, and 80 degrees and 120 degrees are adjacent.

For example, the reference signal resources included in the associated reference signal resource subset all have a second dimensional direction angle of 80 degrees, and the at least one reference signal resource has a second dimensional direction angle of 40 degrees, which indicates that the associated reference signal resource subset includes a reference signal resource having a second dimensional direction angle adjacent to a second dimensional direction angle of the at least one reference signal resource.

Situation 3: the associated reference signal resource subset includes a reference signal resource having a first dimensional direction angle adjacent to a first dimensional direction angle of the at least one reference signal resource, and the associated reference signal resource subset includes a reference signal resource having a second dimensional direction angle adjacent to a second dimensional direction angle of the at least one reference signal resource.

In some embodiments, the beam information includes a reference signal resource subset to which the at least one reference signal resource belongs.

In the embodiments of the present application, each reference signal resource in the at least one reference signal resource has a reference signal resource subset to which it belongs. By means of the at least one reference signal resource, the beam information also includes the reference signal resource subset to which the at least one reference signal resource belongs, so that the reference signal resource subset can also be indicated through the beam information.

For example, the beam information includes an identifier of a reference signal resource subset to which each of the at least one reference signal resource belongs.

For example, the at least one reference signal resource includes: a reference signal resource 1, a reference signal resource 2, and a reference signal resource 3, the reference signal resource 1 and the reference signal resource 2 belonging to a reference signal resource subset 1, and the reference signal resource 3 belonging to a reference signal resource subset 2.

Optionally, beams of all reference signal resources in the reference signal resource subset are adjacent to each other in direction.

In the embodiment of the present application, beams of all reference signal resources in the reference signal resource subset are adjacent to each other in direction, which means that the beam direction of each reference signal resource is narrower and does not cover the beam direction of other reference signal resources.

The beams of all reference signal resources in the reference signal resource subset are adjacent to each other in direction, similar to the beams of all reference signal resources in the associated reference signal resource subset in the above embodiments, which will not be repeated herein.

Optionally, reference signal resources in the reference signal resource subset have a same first dimensional direction angle, and the reference signal resources in the reference signal resource subset have different second dimensional direction angles.

For example, the reference signal resource subset includes a reference signal resource 1, a reference signal resource 2, a reference signal resource 3, and a reference signal resource 4, which all correspond to a first dimensional direction angle of 30 degrees, while the reference signal resource 1 corresponds to a second dimensional direction angle of angle 1, the reference signal resource 2 corresponds to a second dimensional direction angle of angle 2, the reference signal resource 3 corresponds to a second dimensional direction angle of angle 3, and the reference signal resource 4 corresponds to a second dimensional direction angle of angle 4.

In some embodiments, when at least two reference signal resource subsets exist, the at least two reference signal resource subsets correspond to different first dimensional direction angles.

For example, a reference signal resource subset 1 corresponds to a first dimensional direction angle of 30 degrees, a reference signal resource subset 2 corresponds to a first dimensional direction angle of 60 degrees, a reference signal resource subset 3 corresponds to a first dimensional direction angle of 90 degrees, and a reference signal resource subset 4 corresponds to a first dimensional direction angle of 120 degrees.

In the embodiment of the present application, each reference signal resource has a corresponding beam direction. For the above-described at least one reference signal resource, the beam direction of the at least one reference signal resource is adjacent to the beam direction of the reference signal resource included in the associated reference signal resource subset. That is, the beam direction of the at least one reference signal resource does not cover the beam direction of the reference signal resource included in the associated reference signal resource subset, and the beam direction of the at least one reference signal resource and the beam direction of the associated reference signal resource subset are both narrower, thus forming a beam adjacency relationship.

For example, the at least one reference signal resource is associated with four associated reference signal resource subsets, each associated reference signal resource subset includes four reference signal resources, and the four reference signal resources correspond to different second dimensional direction angles.

The reference signal resource subset 1 includes a reference signal resource 1, a reference signal resource 2, a reference signal resource 3, and a reference signal resource 4, which all correspond to a first dimensional direction angle of 30 degrees, and the reference signal resource 1 corresponds to a second dimensional direction angle of angle 1, the reference signal resource 2 corresponds to a second dimensional direction angle of angle 2, the reference signal resource 3 corresponds to a second dimensional direction angle of angle 3, and the reference signal resource 4 corresponds to a second dimensional direction angle of angle 4.

The reference signal resource subset 2 includes a reference signal resource 5, a reference signal resource 6, a reference signal resource 7, and a reference signal resource 8, which all correspond to a first dimensional direction angle of 60 degrees, while the reference signal resource 5 corresponds to a second dimensional direction angle of angle 1, the reference signal resource 6 corresponds to a second dimensional direction angle of angle 2, the reference signal resource 7 corresponds to a second dimensional direction angle of angle 3, and the reference signal resource 8 corresponds to a second dimensional direction angle of angle 4.

The reference signal resource subset 3 includes a reference signal resource 9, a reference signal resource 10, a reference signal resource 11, and a reference signal resource 12, which all correspond to a first dimensional direction angle of 90 degrees, while the reference signal resource 9 corresponds to a second dimensional direction angle of angle 1, the reference signal resource 10 corresponds to a second dimensional direction angle of angle 2, the reference signal resource 11 corresponds to a second dimensional direction angle of angle 3, and the reference signal resource 12 corresponds to a second dimensional direction angle of angle 4.

The reference signal resource subset 4 includes a reference signal resource 13, a reference signal resource 14, a reference signal resource 15, and a reference signal resource 16, which all correspond to a first dimensional direction angle of 120 degrees, while the reference signal resource 13 corresponds to a second dimensional direction angle of angle 1, the reference signal resource 14 corresponds to a second dimensional direction angle of angle 2, the reference signal resource 15 corresponds to a second dimensional direction angle of angle 3, and the reference signal resource 16 corresponds to a second dimensional direction angle of angle 4.

It should be noted that the first dimensional direction angle of the reference signal resource subset in the above embodiments is proportional to the identifier of the reference signal resource subset. That is, the larger the identifier of the reference signal resource subset is, the larger the first dimensional direction angle of the reference signal resource subset is. In addition, the second dimensional direction angle of the reference signal resource included in the reference signal resource subset is proportional to the identifier of the reference signal resource. That is, the larger the identifier of the reference signal resource in the reference signal resource subset, the larger the second dimensional direction angle of the reference signal resource.

In the embodiment of the present application, if the beam information indicates a range of the first dimensional direction angles of the at least one reference signal resource and also includes the number of reference signal resource subsets, the first dimensional direction angle of the reference signal resource subset may be determined.

Optionally, an angular interval of the first dimensional direction angles between two adjacent reference signal resource subsets is determined based on the range of the first dimensional direction angles and the number of reference signal resource subsets, and then a value of the first dimensional direction angle of each reference signal resource subset is determined based on the angular interval.

For example, if a range of the first dimensional direction angles is from −90 degrees to 90 degrees, and the number of reference signal resource subsets is five, an angular interval of the first dimensional direction angles of two adjacent reference signal resource subsets is determined to be 45 degrees. Specifically, the first dimensional direction angle of the first reference signal resource subset is 90 degrees, the first dimensional direction angle of the second reference signal resource subset is 45 degrees, the first dimensional direction angle of the third reference signal resource subset is 0 degrees, the first dimensional direction angle of the fourth reference signal resource subset is −45 degrees, and the first dimensional direction angle of the fifth reference signal resource subset is −90 degrees.

If the beam information indicates a range of the second dimensional direction angles of the at least one reference signal resource and also includes the number of reference signal resources included in the reference signal resource subset, a second dimensional direction angle of each reference signal resource subset of the reference signal resource subsets can be determined.

Optionally, an angular interval of the second dimensional direction angles between two adjacent reference signal resource subsets is determined based on the range of the second dimensional direction angles and a number of reference signal resource subsets, and then a value of the second dimensional direction angle of each reference signal resource subset is determined based on the angular interval.

For example, if a range of the second dimensional direction angles is from −90 degrees to 90 degrees, and the number of reference signal resource subsets is five, an angular interval of the second dimensional direction angles of two adjacent reference signal resource subsets is determined to be 45 degrees. Specifically, the second dimensional direction angle of the first reference signal resource subset is 90 degrees, the second dimensional direction angle of the second reference signal resource subset is 45 degrees, the second dimensional direction angle of the third reference signal resource subset is 0 degrees, the second dimensional direction angle of the fourth reference signal resource subset is −45 degrees, and the second dimensional direction angle of the fifth reference signal resource subset is −90 degrees.

On the basis of the embodiment shown in FIG. 2, the beam information includes parameter information of the at least one reference signal resource.

The parameter information includes at least one of the following items.

### (1) Beam Identifier Corresponding to Each Reference Signal Resource.

Each reference signal resource corresponds to a beam, and each beam can be indicated by an identifier. For example, a beam identifier corresponding to a reference signal resource is an ID of the beam.

### (2) Total Number of Beams Corresponding to all Reference Signal Resources.

It should be noted that in the embodiment of the present application, it refers to the beam information used by the second device for sending the reference signal.

### (3) First Dimensional Direction Angle Corresponding to Each Reference Signal Resource.

In the embodiment of the present application, each reference signal resource corresponds to a first dimensional direction angle that has a value, and the beam information includes the first dimensional direction angle corresponding to each reference signal resource.

### (4) Second Dimensional Direction Angle Corresponding to Each Reference Signal Resource.

In the embodiment of the present application, each reference signal resource corresponds to a second dimensional direction angle that has a value, and the beam information includes the second dimensional direction angle corresponding to each reference signal resource.

### (5) Number of the First Dimensional Direction Angles.

In the embodiment of the present application, the number of the first dimensional direction angles is used when the second device sends the reference signals. That is, the number of first dimensional direction angles having different values is used by the second device. The first dimensional direction angle is a first dimensional direction angle corresponding to a transmitting beam of the second device. The second device can indicate the number of first dimensional direction angles used, to facilitate the first device to determine the number of first dimensional direction angles used by the second device, and furthermore, the first device can determine a value for each first dimensional direction angle based on the number of first dimensional direction angles.

In some embodiments, after determining the number of first dimensional directional angles, a value for each first dimensional directional angle can be determined based on the range of the first dimensional directional angles and the number of first dimensional directional angles.

Optionally, the number of the first dimensional directional angles is obtained, and then a range of the first dimensional directional angles is obtained to determine an angular interval between two adjacent first dimensional directional angles, and finally a value for each first dimensional directional angle is determined based on the angular interval.

For example, if the range of the first dimensional direction angles is from −90 degrees to 90 degrees and the number of the first dimensional direction angles is five, it is determined that the angular interval between two adjacent first dimensional direction angles is 45 degrees. Specifically, the angle of the first one of the first dimensional direction angles is 90 degrees, the angle of the second one of the first dimensional direction angles is 45 degrees, the angle of the third one of the first dimensional direction angles is 0 degrees, the angle of the fourth one of the first dimensional direction angles is −45 degrees, and the fifth one of the first dimensional direction angles is −90 degrees.

It should be noted that the range of the first dimensional direction angles in the embodiment of the present application is included in the beam information, or, alternatively, the range of the first dimensional direction angles is specified by the protocol, which is not limited in the embodiment of the present application.

### (6) Number of the Second Dimensional Direction Angles.

In the embodiment of the present application, the second device indicates the number of second dimensional direction angles, that is, the number of second dimensional direction angles having different values used by the second device. Here, the second dimensional direction angle is a second dimensional direction angle corresponding to a transmitting beam of the second device. The second device can indicate the number of second dimensional direction angles used, to facilitate the first device to determine the number of second dimensional direction angles used by the second device, and furthermore, the first device can determine a value for each second dimensional direction angle based on the number of second dimensional direction angles.

In some embodiments, after determining the number of second dimensional directional angles, a value for each second dimensional directional angle can be determined based on the range of the second dimensional directional angles and the number of second dimensional directional angles.

Optionally, the number of the second dimensional directional angles is obtained, and then a range of the second dimensional directional angles is obtained to determine an angular interval between two adjacent second dimensional directional angles, and finally a value for each second dimensional directional angle is determined based on the angular interval.

For example, if the range of the second dimensional direction angles is from 0 degrees to 90 degrees and the number of the second dimensional direction angles is 4, it is determined that the angular interval between two adjacent second dimensional direction angles is 30 degrees. Specifically, the angle of the first one of the second dimensional direction angles is 0 degrees, the angle of the second one of the second dimensional direction angles is 30 degrees, the angle of the third one of the second dimensional direction angles is 60 degrees, and the angle of the fourth one of the second dimensional direction angles is 90 degrees.

It should be noted that the range of the second dimensional direction angles in the embodiment of the present application is included in the beam information, or, alternatively, the range of the second dimensional direction angles is specified by the protocol, which is not limited in the embodiment of the present application.

In addition, there is an implicit correspondence between the first dimensional direction angle and the transmitting beam in the embodiment of the present application. That is, after the second device indicates the value of the first dimensional direction angle or the identifier of the first dimensional direction angle, based on the value of the first dimensional direction angle or the identifier of the first dimensional direction angle, the first device can determine the identifier of the corresponding transmitting beam.

Moreover, there is an implicit correspondence between the second dimensional direction angle and the transmitting beam in the embodiment of the present application. That is, after the second device indicates the value of the second dimensional direction angle or the identifier of the second dimensional direction angle, based on the value of the second dimensional direction angle or the identifier of the second dimensional direction angle, the first device can determine the identifier of the corresponding transmitting beam.

It should be noted that the first dimensional direction angle in the embodiment of the present application is a horizontal direction angle and the second dimensional direction angle is a vertical direction angle, or, the first dimensional direction angle is a vertical direction angle and the second dimensional direction angle is a horizontal direction angle.

For example, for the Global Coordinate System (GCS), a horizontal direction angle (i.e., an azimuth angle) is determined based on the north of the geographic location, while a vertical direction angle (i.e., an elevation angle) is determined based on the zenith and the horizontal direction, i.e., an elevation of 0 degrees indicates the zenith, and 90 degrees relative to the horizontal direction.

For the Local Coordinate System (LCS), the azimuth angle is determined based on the X-axis of the LCS, and the elevation angle is based on the Z-axis of the LCS, i.e., an elevation of 0 indicates a 0-degree relative to the Z-axis, and a 90-degree angle relative to the X-Y plane.

### (7) Number of Antenna Array Elements in Each Antenna Array.

The antenna array is an antenna array provided in the second device. The antenna array includes antenna array elements and the antenna array elements are arranged in a matrix manner to form the antenna array. Thus, the number of antenna array elements is carried in the beam information to indicate how many antenna array elements form the antenna array.

### (8) Number of Rows of the Antenna Array Elements in Each Antenna Array.

The antenna array elements are arranged in a matrix manner to form an antenna array. The number of rows of the antenna array elements is carried in the beam information to indicate how many rows of antenna array elements form the antenna array.

### (9) Number of Columns of the Antenna Array Elements in Each Antenna Array.

If the antenna array elements are arranged in a matrix manner to form an antenna array, the number of columns of the antenna array elements is carried in the beam information to indicate how many columns of the antenna array elements form the antenna array.

### (10) Row Identifier of an Antenna Array Element in a Corresponding Antenna Array.

In the embodiment of the present application, a row identifier in the antenna array is used to indicate a row position of the antenna array element in the antenna array.

### (11) Column Identifier of an Antenna Array Element in a Corresponding Antenna Array.

In the embodiment of the present application, a column identifier in the antenna array is used to indicate a column position of the antenna array element in the antenna array.

### (12) Spacing Between Adjacent Antenna Array Elements.

In the embodiment of the present application, a plurality of antenna array elements are used to form an antenna array, and for two adjacent antenna array elements, the two antenna array elements have spacing between them, by which a distance between the antenna array elements is indicated.

### (13) Spacing Between Adjacent Antenna Arrays.

In the embodiment of the present application, communication is carried out through a plurality of antenna arrays, and for two adjacent antenna arrays, the two antenna arrays have spacing between them, by which a distance between the antenna arrays is indicated.

### (14) Number of Antenna Arrays.

In the embodiment of the present application, the number of antenna arrays included in the second device is indicated by beam information. For example, the number of antenna arrays is 2, 4 or some other value.

It should be noted that the position of each antenna array in the second device can be determined in the embodiment of the present application by the positions of the antenna array elements in the antenna array, as well as the parameters between the antenna arrays. Since different antenna arrays correspond to different beams, the transmitting beam identifiers can be determined based on the antenna arrays. Subsequently, the first device can, based on the determined transmitting beam identifiers and the signal quality prediction model, predict the signal quality of the unmeasured other reference signal(s). In addition, different spacing between the antenna elements and different spacing between the antenna arrays will affect the antenna gain. After determining the antenna gain based on the above parameters, the first device can subsequently predict the signal quality of the unmeasured other reference signal(s) based on the determined antenna gain and the signal quality prediction model.

In some embodiments, the beam information includes energy information of the at least one reference signal resource, the energy information indicating energy for each of the at least one reference signal resource.

In the embodiment of the present application, the energy of the reference signal resource is represented by “power”. Additionally, different reference signal resources correspond to different beam directions, which means that the energy of the reference signal resource can also be referred to as the antenna gain in each beam direction.

Optionally, for each reference signal resource of a plurality of reference signal resources, the beam information indicates the energy of a reference signal resource, and the energy information includes the differential value(s) relative to the energy of that reference signal resource. The energy of respective reference signal resources is indicated by the differential values represented by the energy information of the respective reference signal resources.

It should be noted that the steps performed in the embodiment of the present application are similar to the steps performed in the embodiments described above and will not be repeated herein.

FIG. 7 illustrates a block diagram of an information transmission apparatus provided by an embodiment of the present application. Referring to FIG. 7, the apparatus includes:
a receiving module 701 configured to receive beam information from a second device, where the beam information indicates beam information corresponding to at least one reference signal resource, the at least one reference signal resource including a resource for beam measurement.

In some embodiments, the beam information includes information of an associated reference signal resource subset of the at least one reference signal resource.

In some embodiments, the information of the associated reference signal resource subset includes an identifier of the associated reference signal resource subset and an identifier of a reference signal resource in the associated reference signal resource subset.

In some embodiments, the associated reference signal resource subset includes a reference signal resource that is in a same set of reference signal resources as the at least one reference signal resource; or, the associated reference signal resource subset includes a reference signal resource that is in a different set of reference signal resources from the at least one reference signal resource.

In some embodiments, the associated reference signal resource subset includes a reference signal resource having a beam direction within a range of a beam direction of the at least one reference signal resource; or, the associated reference signal resource subset includes a reference signal resource having a beam direction adjacent to a beam direction of the at least one reference signal resource.

In some embodiments, the associated reference signal resource subset includes a reference signal resource having a first dimensional direction angle within a range of first dimensional direction angles of the at least one reference signal resource, and/or, the associated reference signal resource subset includes a reference signal resource having a second dimensional direction angle within a range of second dimensional direction angles of the at least one reference signal resource;
or, the associated reference signal resource subset includes a reference signal resource having a first dimensional direction angle adjacent to a first dimensional direction angle of the at least one reference signal resource, and/or, the associated reference signal resource subset includes a reference signal resource having a second dimensional direction angle adjacent to a second dimensional direction angle of the at least one reference signal resource.

In some embodiments, the beam information includes a reference signal resource subset to which the at least one reference signal resource belongs.

In some embodiments, beams of all reference signal resources in the reference signal resource subset are adjacent to each other in direction.

In some embodiments, first dimensional direction angles corresponding to reference signals in the reference signal resource subset are the same, and second dimensional direction angles corresponding to the reference signals in the reference signal resource subset are different.

In some embodiments, when at least two reference signal resource subsets exist, the at least two reference signal resource subsets correspond to different first dimensional direction angles.

In some embodiments, the beam information includes parameter information of the at least one reference signal resource;
the parameter information includes at least one of:
a beam identifier corresponding to each reference signal resource of the at least one reference signal resource;
a total number of beams corresponding to all reference signal resources of the at least one reference signal resource;
a first dimensional direction angle corresponding to each reference signal resource of the at least one reference signal resource;
a second dimensional direction angle corresponding to each reference signal resource of the at least one reference signal resource;
a number of the first dimensional direction angles;
a number of the second dimensional direction angles;
a number of antenna array elements in each antenna array;
a number of rows of the antenna array elements in each antenna array;
a number of columns of the antenna array elements in each antenna array;
a row identifier of an antenna array element in a corresponding antenna array;
a column identifier of an antenna array element in a corresponding antenna array;
spacing between adjacent antenna array elements;
spacing between adjacent antenna arrays; or a number of antenna arrays.

In some embodiments, the beam information includes energy information of the at least one reference signal resource, the energy information indicating energy of each reference signal resource of the at least one reference signal resource.

In some embodiments, the first device is a terminal and the second device is a network device.

In some embodiments, the reference signal resource includes an SSB or CSI-RS.

In some embodiments, the first device is a network device and the second device is a terminal.

In some embodiments, the reference signal resource includes an SRS.

In some embodiments, the beam measurement includes: a measurement for L1-RSRP of the at least one reference signal resource; and/or a measurement for L1-SINR of the at least one reference signal resource.

It should be noted that the apparatus provided by the above embodiments, in realizing its functions, is only exemplified by the division of each functional module described above, and in actual application, the above functions can be assigned to be completed by different functional modules according to the needs, i.e., the internal structure of the apparatus is divided into different functional modules to complete all or part of the above-described functions. In addition, the apparatus provided in the above embodiments belongs to the same concept as the method embodiments, and its specific realization process is detailed in the method embodiments, which will not be repeated here.

FIG. 8 illustrates a block diagram of an information transmission apparatus provided by an embodiment of the present application. Referring to FIG. 8, the apparatus includes:
a sending module 801 configured to send beam information to a first device, where the beam information indicates beam information corresponding to at least one reference signal resource, the at least one reference signal resource including a resource for beam measurement.

In some embodiments, the beam information includes information of an associated reference signal resource subset of the at least one reference signal resource.

In some embodiments, the information of the associated reference signal resource subset includes an identifier of the associated reference signal resource subset and an identifier of a reference signal resource in the associated reference signal resource subset.

In some embodiments, the associated reference signal resource subset includes a reference signal resource that is in a same set of reference signal resources as the at least one reference signal resource; or, the associated reference signal resource subset includes a reference signal resource that is in a different set of reference signal resources from the at least one reference signal resource.

In some embodiments, the associated reference signal resource subset includes a reference signal resource having a beam direction within a range of a beam direction of the at least one reference signal resource; or, the associated reference signal resource subset includes a reference signal resource having a beam direction adjacent to a beam direction of the at least one reference signal resource.

In some embodiments, the associated reference signal resource subset includes a reference signal resource having a first dimensional direction angle within a range of first dimensional direction angles of the at least one reference signal resource, and/or, the associated reference signal resource subset includes a reference signal resource having a second dimensional direction angle within a range of second dimensional direction angles of the at least one reference signal resource;
or, the associated reference signal resource subset includes a reference signal resource having a first dimensional direction angle adjacent to a first dimensional direction angle of the at least one reference signal resource, and/or, the associated reference signal resource subset includes a reference signal resource having a second dimensional direction angle adjacent to a second dimensional direction angle of the at least one reference signal resource.

In some embodiments, the beam information includes a reference signal resource subset to which the at least one reference signal resource belongs.

In some embodiments, beams of all reference signal resources in the reference signal resource subset are adjacent to each other in direction.

In some embodiments, first dimensional direction angles corresponding to reference signals in the reference signal resource subset are the same, and second dimensional direction angles corresponding to the reference signals in the reference signal resource subset are different.

In some embodiments, when at least two reference signal resource subsets exist, the at least two reference signal resource subsets correspond to different first dimensional direction angles.

In some embodiments, the beam information includes parameter information of the at least one reference signal resource;
the parameter information includes at least one of:
a beam identifier corresponding to each reference signal resource of the at least one reference signal resource;
a total number of beams corresponding to all reference signal resources of the at least one reference signal resource;
a first dimensional direction angle corresponding to each reference signal resource of the at least one reference signal resource;
a second dimensional direction angle corresponding to each reference signal resource of the at least one reference signal resource;
a number of the first dimensional direction angles;
a number of the second dimensional direction angles;
a number of antenna array elements in each antenna array;
a number of rows of the antenna array elements in each antenna array;
a number of columns of the antenna array elements in each antenna array;
a row identifier of an antenna array element in a corresponding antenna array;
a column identifier of an antenna array element in a corresponding antenna array;
spacing between adjacent antenna array elements;
spacing between adjacent antenna arrays; or
a number of antenna arrays.

In some embodiments, the beam information includes energy information of the at least one reference signal resource, the energy information indicating energy of each reference signal resource of the at least one reference signal resource.

In some embodiments, the first device is a terminal and the second device is a network device.

In some embodiments, the reference signal resource is an SSB or CSI-RS.

In some embodiments, the first device is a network device and the second device is a terminal.

In some embodiments, the reference signal resource includes an SRS.

In some embodiments, the beam measurement includes: a measurement for L1-RSRP of the at least one reference signal resource; and/or a measurement for L1-SINR of the at least one reference signal resource.

It should be noted that the apparatus provided by the above embodiments, in realizing its functions, is only exemplified by the division of each functional module described above, and in actual application, the above functions can be assigned to be completed by different functional modules according to the needs, i.e., the internal structure of the apparatus is divided into different functional modules to complete all or part of the above-described functions. In addition, the apparatus provided in the above embodiments belongs to the same concept as the method embodiments, and its specific realization process is detailed in the method embodiments, which will not be repeated here.

FIG. 9 illustrates a schematic diagram of a structure of a communication device provided by an embodiment of the present application, the communication device including: a processor 901, a receiver 902, a transmitter 903, a memory 904, and a bus 905.

The processor 901 includes one or more processing cores, and the processor 901 performs various functional applications as well as information processing by running software programs as well as modules.

The receiver 902 and the transmitter 903 may be implemented as a communication component, which may be a communication chip.

The memory 904 is connected to the processor 901 via the bus 905.

The memory 904 may be used to store at least one program code, and the processor 901 is used to execute the at least one program code to implement the various steps in the method embodiments described above.

In addition, the communication device may be a first device or a second device. The memory 904 may be implemented by any type of volatile or non-volatile storage device or a combination thereof. The volatile or non-volatile storage devices include, but are not limited to: disks or optical disks, electrically erasable programmable read-only memory (EEPROM), erasable programmable read-only memory (EPROM), static ready-to-access memory (SRAM), read-only memory (ROM), magnetic memory, flash memory, and programmable read-only memory (PROM).

In embodiments, there is also provided a computer-readable storage medium, said computer-readable storage medium having executable program code stored therein, said executable program code being loaded and executed by a processor to implement the method for transmitting information performed by a communication device provided by the above method embodiments.

In embodiments, a chip is provided, said chip including programmable logic circuitry and/or program instructions for implementing a method for transmitting information as provided in various method embodiments when said chip is operated on a first device or a second device.

In embodiments, a computer program product is provided which, when said computer program product is executed by a processor of a terminal or a network device, is used to implement the method for transmitting information provided by the above method embodiments.

A person of ordinary skill in the art may understand that all or some of the steps for realizing the above embodiments may be accomplished by hardware, or may be accomplished by a program that instructs the relevant hardware to do so, and said program may be stored in a computer-readable storage medium, and the storage medium may be a read-only memory, a disk or a CD-ROM, or the like.

The foregoing are only optional embodiments of this application and are not intended to limit this application, and any modifications, equivalent substitutions, improvements, etc., made within the spirit and principles of this application shall be included in the scope of protection of this application.

1. A method for transmitting information, performed by a first device, the method comprising:
receiving beam information from a second device, wherein the beam information indicates beam information corresponding to at least one reference signal resource, the at least one reference signal resource comprising a resource for beam measurement.

2. The method according to claim 1, wherein the beam information comprises information of an associated reference signal resource subset of the at least one reference signal resource.

3. The method according to claim 2, wherein the information of the associated reference signal resource subset comprises an identifier of the associated reference signal resource subset and an identifier of a reference signal resource in the associated reference signal resource subset.

4. The method according to claim 2, wherein the associated reference signal resource subset comprises a reference signal resource that is in a same set of reference signal resources as the at least one reference signal resource, or
the associated reference signal resource subset comprises a reference signal resource that is in a different set of reference signal resources from the at least one reference signal resource.

5. The method according to claim 2, wherein the associated reference signal resource subset comprises a reference signal resource having a beam direction within a range of a beam direction of the at least one reference signal resource,
the associated reference signal resource subset comprises a reference signal resource having a beam direction adjacent to a beam direction of the at least one reference signal resource.

6. The method according to claim 2, wherein the associated reference signal resource subset comprises at least one of:
a reference signal resource having a first dimensional direction angle within a range of first dimensional direction angles of the at least one reference signal resource,
a reference signal resource having a second dimensional direction angle within a range of second dimensional direction angles of the at least one reference signal resource,
a reference signal resource having a first dimensional direction angle adjacent to a first dimensional direction angle of the at least one reference signal resource, and
a reference signal resource having a second dimensional direction angle adjacent to a second dimensional direction angle of the at least one reference signal resource.

7. The method according to claim 1, wherein the beam information comprises a reference signal resource subset to which the at least one reference signal resource belongs,
beams of all reference signal resources in the reference signal resource subset are adjacent to each other in direction,
reference signal resources in the reference signal resource subset have a same first dimensional direction angle and the reference signal resources in the reference signal resource subset have different second dimensional direction angles, and
when at least two reference signal resource subsets exist, the at least two reference signal resource subsets correspond to different first dimensional direction angles.

8-10. (canceled)

11. The method according to claim 1, wherein the beam information comprises parameter information of the at least one reference signal resource, and
wherein the parameter information comprises at least one of:
a beam identifier corresponding to each reference signal resource of the at least one reference signal resource;
a total number of beams corresponding to all reference signal resources of the at least one reference signal resource;
a first dimensional direction angle corresponding to each reference signal resource of the at least one reference signal resource;
a second dimensional direction angle corresponding to each reference signal resource of the at least one reference signal resource;
a number of the first dimensional direction angles;
a number of the second dimensional direction angles;
a number of antenna array elements in each antenna array;
a number of rows of the antenna array elements in each antenna array;
a number of columns of the antenna array elements in each antenna array;
a row identifier of an antenna array element in a corresponding antenna array;
a column identifier of an antenna array element in a corresponding antenna array;
spacing between adjacent antenna array elements;
spacing between adjacent antenna arrays; or
a number of antenna arrays.

12. (canceled)

13. The method according to claim 1, wherein the first device is a terminal and the second device is a network device, and the at least one reference signal resource comprises a Synchronization Signal Block (SSB) resource or a Channel State Information Reference Signal (CSI-RS) resource, or
wherein the first device is a network device and the second device is a terminal; and the at least one reference signal resource comprises a Sounding Reference Signal (SRS) resource.

14-16. (canceled)

17. The method according to claim 1, wherein the beam measurement comprises at least one of:
a measurement for Layer 1 Reference Signal Receiver Power (L1-RSRP) of the at least one reference signal resource,
a measurement for Layer 1 Signal to Interference plus Noise Ratio (L1-SINR) of the at least one reference signal resource.

18. A method of transmitting information, performed by a second device, the method comprising:
sending beam information to a first device, wherein the beam information indicates beam information corresponding to at least one reference signal resource, the at least one reference signal resource comprising a resource for beam measurement.

19. The method according to claim 18, wherein the beam information comprises information of an associated reference signal resource subset of the at least one reference signal resource.

20. The method according to claim 19, wherein the information of the associated reference signal resource subset comprises an identifier of the associated reference signal resource subset and an identifier of a reference signal resource in the associated reference signal resource subset.

21. The method according to claim 19, wherein the associated reference signal resource subset comprises:
a reference signal resource that is in a same set of reference signal resources as the at least one reference signal resource,
the associated reference signal resource subset comprises a reference signal resource that is in a different set of reference signal resources from the at least one reference signal resource.

22. The method according to claim 19, wherein the associated reference signal resource subset comprises a reference signal resource having a beam direction within a range of a beam direction of the at least one reference signal resource, or
the associated reference signal resource subset comprises a reference signal resource having a beam direction adjacent to a beam direction of the at least one reference signal resource.

23. The method according to claim 19, wherein the associated reference signal resource subset comprises at least one of:
a reference signal resource having a first dimensional direction angle within a range of first dimensional direction angles of the at least one reference signal resource,
a reference signal resource having a second dimensional direction angle within a range of second dimensional direction angles of the at least one reference signal resource,
reference signal resource having a first dimensional direction angle adjacent to a first dimensional direction angle of the at least one reference signal resource, or
a reference signal resource having a second dimensional direction angle adjacent to a second dimensional direction angle of the at least one reference signal resource.

24. The method according to claim 18, wherein the beam information comprises a reference signal resource subset to which the at least one reference signal resource belongs,
beams of all reference signal resources in the reference signal resource subset are adjacent to each other in direction,
reference signal resources in the reference signal resource subset have a same first dimensional direction angle and the reference signal resources in the reference signal resource subset have different second dimensional direction angles, and
when at least two reference signal resource subsets exist, the at least two reference signal resource subsets correspond to different first dimensional direction angles.

25-27. (canceled)

28. The method according to claim 18, wherein the beam information comprises parameter information of the at least one reference signal resource, and
wherein the parameter information comprises at least one of:
a beam identifier corresponding to each reference signal resource of the at least one reference signal resource;
a total number of beams corresponding to all reference signal resources of the at least one reference signal resource;
a first dimensional direction angle corresponding to each reference signal resource of the at least one reference signal resource;
a second dimensional direction angle corresponding to each reference signal resource of the at least one reference signal resource;
a number of the first dimensional direction angles;
a number of the second dimensional direction angles;
a number of antenna array elements in each antenna array;
a number of rows of the antenna array elements in each antenna array;
a number of columns of the antenna array elements in each antenna array;
a row identifier of an antenna array element in a corresponding antenna array;
a column identifier of an antenna array element in a corresponding antenna array;
spacing between adjacent antenna array elements;
spacing between adjacent antenna arrays; or
a number of antenna arrays.

29. (canceled)

30. The method according to claim 18, wherein the first device is a terminal and the second device is a network device, and the at least one reference signal resource comprises a Synchronization Signal Block (SSB) resource or a Channel State Information Reference Signal (CSI-RS) resource, or
wherein the first device is a network device and the second device is a terminal; and the at least one reference signal resource comprises a Sounding Reference Signal (SRS) resource.

31-36. (canceled)

37. A device, comprising:
a processor; and
a transceiver connected to the processor,
wherein the processor is configured to load and execute an executable instruction to implement the method for transmitting information according to claim 1.

38-39. (canceled)
